(19) United States
(12) Patent Application Publication
(10) Pub. No.: US 2014/0195277 A1
(43) Pub. Date: Jul. 10, 2014

(54) SYSTEMS AND METHODS FOR GENERATING DYNAMIC SEATING CHARTS

(71) Applicant: Stanley H. KIM, San Diego, CA (US)

(72) Inventor: Stanley H. KIM, San Diego, CA (US)

(21) Appl. No.: 14/148,354

(22) Filed: Jan. 6, 2014

Related U.S. Application Data
(60) Provisional application No. 61/749,303, filed on Jan. 5, 2013.

(51) Int. Cl. G06Q 10/02

(52) U.S. Cl. CPC G06Q 10/02
USPC 705/5

(57) ABSTRACT

This invention relates to systems and methods for creating seating charts in digital form, and more particularly to systems and methods for user-driven creation and visualization of interactive digital seating charts, particularly for ticketing and reservations systems.

### RELATED U.S. APPLICATIONS

This application claims priority to U.S. Provisional Application No. 61/749,303 filed on Jan. 5, 2013 and entitled “Systems and Methods for Generating Dynamic Seating Charts” which is hereby incorporated by reference in its entirety.

### BACKGROUND

1. Field of the Invention

This invention relates to systems and methods for creating seating charts in digital form, and more particularly to systems and methods for user-driven creation and visualization of interactive digital seating charts, particularly for ticketing and reservations systems.

2. Description of the Related Art

Many systems are known for providing electronic tickets to different events. However, each event normally is hosted in one of a variety of different venues. In order to create ticketing solutions, each seating within the venues needs to be assigned a specific number or identifier so that two different patrons aren't sold tickets to the same venue seat. Some systems, such as the website socialtables.com allow one to electronically design layouts of seats for planning an event. However, these systems do not provide a robust and automated way of capturing the format of a particular venue and thereafter providing a ticketing service to handle seat assignments and other ticketing functions.

### SUMMARY

Systems and methods described herein provide interactive, user-driven generation of a dynamic seating chart. A dynamic seating chart can be used as an interactive interface for users to visually manage a venue's seating inventory for such purposes as a ticketing and reservation system. A user can automatically or manually create a flexible seating map that user can quickly modify to dynamically reflect a seating configuration of an evolving venue. The map can be linked to information about individual seats such as location and pricing information, and further displayed with additional information useful to individuals associated with the venue or events at the venue, and the attendees (of the venue/event).

Various embodiments relate to systems and methods for generating, preferably in a network-based system, an interactive illustration showing where a particular seat is located in an event venue. The system receives visual or dimensional input from a user to generate a digital map that can be displayed as a representative map of the venue; information to create identifiers for each seat in the venue (whether specific or general), and additional information such as pricing, zoning or other characteristic that may be necessary for the user and/or end-user to visually manage reservations, inventory, sales, and other interests.

Visual or textual input is received by the system to generate a visual interactive and informative display of seats, and more importantly, venue inventory. The system can prompt the user to input photos, schematics, drawings or other illustration to automatically, or with the aid of the user, generate a digital overlay representation that displays the seating arrangement of the venue. The system can link the input illustration with the digital overlay. Alternatively, the system can prompt the user for dimensional information about the venue to create a digital representation of the seating arrangement of the venue. The user can quickly modify and manipulate this seating map to accurately reflect the actual seating arrangement of the venue, particularly as a tool to visualize seating inventory and related information for the user, venue and event organizers and to end-users looking to reserve seating.

Information related to each seat is then generated to identify, for example, inventory purposes, the location of each seat, quantity of seats and/or characteristics of seats. Identifiers can be created for each seat or for blocks of seats. Additional information can be further associated with the seat information, for example, section or zoning associations, pricing, end-user reservations, sales, and other information relevant to the user.

The systems and methods disclosed herein provide, in one embodiment, an application for creating and displaying a dynamic seating chart, particularly for a venue such as a stadium, theater or other venue. In one embodiment, a user can create a dynamic seating chart that can be easily managed and changed as the seats and venue evolve. Through such seating charts, a user can visually manage inventory, analyze usage and sales, and visually rearrange seats to accommodate maximum usage. In addition, consumers can be presented information about one or more seats at a venue, and be presented an online interface to purchase electronic tickets and/or a link to view additional information associated with the tickets and/or seat.

In yet another aspect of the invention, a computer program product for generating a dynamic seating chart is embodied on a computer readable medium and when executed by a computer, performs the method comprising generating a digital seating map, generating one or more seat identifiers for each seat in the digital map associated with a database, and thereafter linking the seating map with a seat.

Additional aspects related to the invention will be set forth in part in the description which follows, and in part will be apparent from the description, or may be learned by practice of the invention. Aspects of the invention may be realized and attained by means of the elements and combinations of various elements and aspects particularly pointed out in the following detailed description and the appended claims.

It is to be understood that both the foregoing and the following descriptions are exemplary and explanatory only and are not intended to limit the claimed invention or application thereof in any manner whatsoever.

### BRIEF DESCRIPTION OF THE DRAWINGS

The accompanying drawings, which are incorporated in and constitute a part of this specification, exemplify the embodiments of the present invention and, together with the description, serve to explain and illustrate principles of the invention. Specifically:

FIG. 1 illustrates a block diagram of a system for generating dynamic seating charts;

FIG. 2 illustrates a block diagram of a detailed view of a system for generating dynamic seating charts;

FIG. 3 illustrates a flow diagram for creating an outline of a venue;

FIG. 4 illustrates a schematic of a football stadium with representative sections;

FIG. 5 illustrates a schematic of a theater with representative sections;

FIG. 6 illustrates a schematic of a room with tables and seating;

FIG. 7 is an image of a theater with an outline overlay of the entire seating area for the venue;

FIG. 8 shows outlines of venues generated by wizards and templates that guide the user to create ;

FIG. 9 is an illustration of form fields where specific symbols can be identified to determine the form field type, according to one embodiment of the invention;

FIG. 10 illustrates a flow diagram for creating the sections of a venue;

FIG. 11 illustrates a schematic of seating chart for a theater;

FIG. 12 shows an exemplary digital seating map superimposed over a seating chart for a theater;

FIG. 13 is an exemplary illustration of a digital seating map being generated by a user by placing seating markers on top of the seat of the schematic;

FIG. 14 is an exemplary digital seating map of a theater generated by the system;

FIG. 15 is an exemplary digital seating map of a room with tables generated by the system.;

FIG. 16 illustrates exemplary user drop-down palettes with default shapes to use in generating a seating map;

FIG. 17 is a flow diagram for generating a seating map for a section of seats using grids and tables;

FIG. 18 is an illustration of a seating map with seating identification being generated based on parameters input into system;

FIG. 19 is a flow diagram for creating seating identifiers, according to one embodiment of the invention;

FIG. 20 is an illustration of data stores accessed to generate a dynamic seating chart with seating, pricing and additional information associated directly or indirectly with seating chart;

FIG. 21 is an illustration of a visual seat chart for the seller to browse and click to see information about the generation of a dynamic seating chart and activity for the seats;

FIG. 22 is an illustration of a dynamic seating chart for a customers to access individual seating information;

FIG. 23 is an illustration of a computer system 2300 that can perform embodiments of the invention; and

FIG. 24 is an illustration of devices and computer systems to access the online system.

### DETAILED DESCRIPTION

In the following detailed description, reference will be made to the accompanying drawings. The aforementioned accompanying drawings show by way of illustration, and not by way of limitation, specific embodiments and implementations consistent with principles of the present invention.

The systems and methods disclosed herein provide, in one embodiment, an application for creating and displaying a dynamic seating chart, particularly for a venue such as a stadium, theater or other venue. In one embodiment, a user can create a dynamic seating chart that can be easily managed and changed as the seats and venue may evolve. Through such seating charts, a consumer can be presented information about one or more seats at a venue, and be presented an online interface to purchase electronic tickets and/or a link to view additional information associated with the tickets and/or seat.

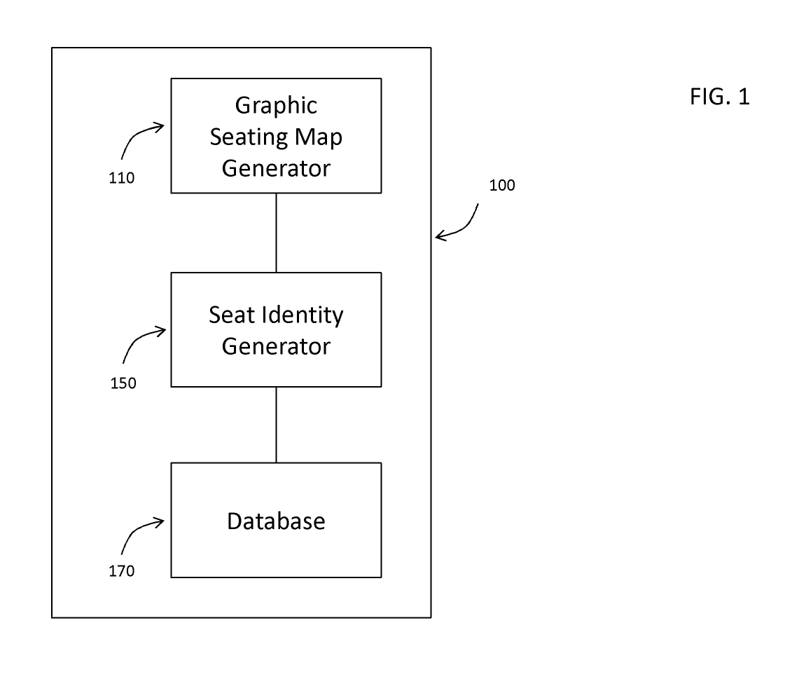

FIG. 1 illustrates a seating chart generation system suitable for implementing various embodiments of the present invention. The elements of the seating chart generation system generally may comprise physical or logical entities for generating digital seating charts, in some cases, may be implemented as hardware, software, or combination thereof, as desired for a given set of design parameters or performance constraints. Although FIG. 1 includes a limited number of elements for purposes of illustration, it can be appreciated that the invention system may include more or less elements as well as other types of elements. In an embodiment, the present invention comprises a graphic seating map generator 110, a seat identity generator 150 associated with a seat database 170 to store seating and other information, with the correlation of the seating information with the digital seating map to generate a dynamic interactive seating chart 100.

It is to be understood that while a particular interactive seating chart may be described, the embodiments are not limited to such context. Furthermore, it is to be understood that while a particular interactive seat chart may be described as comprising a certain set of features and functions, an interactive seat map may comprise fewer features and functions, additional features and functions, and/or a combination of various features and functions of different user interfaces in accordance with the described embodiments.

As defined herein, the term “venue” or “venue” refer to any stadium(s), arena(s), theatre(s), movie theatre(s), concert hall(s), museum(s), performance hall(s), indoor stadium(s), indoor arena(s), indoor theatre(s), indoor movie theatre(s), indoor concert hall(s), indoor museum(s), indoor performance hall(s), outdoor stadium(s), outdoor arena(s), outdoor theatre(s), outdoor movie theatre(s), outdoor concert hall(s), outdoor museum(s), outdoor performance hall(s), and/or any other place(s) or location(s) where any of the herein-described and/or herein-defined events can be held, take place, and/or occur.

A venue can include any location of a scheduled event to be viewed by spectators. Non-limiting examples of performance venues include theaters, stadiums, arenas, halls, clubs, rooms and auditoriums. A performance venue includes a plurality of seats and a performance space. A venue can also include non-spectator sites or slots such as campgrounds, restaurants, ballrooms and convention centers, cubicles or other such spaces, where tickets and reservations may be sold or otherwise offered.

As used herein, a “seat” can include any pre-defined viewing location within a performance venue, and does not necessarily require a physical seat. Non-limiting examples of seats include chairs, benches, tables (with and without individual chairs), drive-in theater parking spots, reservations and score desks. As used herein, a “space” can include any location within a venue where the scheduled event to be viewed will primarily occur. Non-limiting examples of performance spaces include stages, fields and courts.

As defined herein, the term “ticket” or “tickets” refer to any tickets, conventional tickets, physical tickets, electronic tickets, digital tickets, mobile tickets, admissions, registrations, reservations, licenses, invitations, and/or any other mode or means, for allowing and/or permitting entry into, attendance at or in, and/or any other presence at or in, an event or venue, a sporting event or venue, a theatrical event or venue, a movie event or venue, an entertainment event or venue, a concert event or venue, and/or any other event or venue for which tickets and reservations, may be sold or otherwise offered.

As defined herein, the terms “event” or “events” refer to any event, sporting event(s), baseball game(s), basketball game(s), football game(s), hockey game(s), tennis event(s), swimming event(s), skiing event(s), athletic event(s), athletic competition event(s), Olympic event(s), and/or any game(s), event(s), tournament, and/or competition(s), theatrical event or performance, movie event or performance, entertainment event or performance, concert event or performance, and/or any other event or performance for tickets or registration may be sold or otherwise offered.

As defined herein, the terms “user”, “individual”, or the plurals of same, refer to any user, individual, venue owner or promoter, ticket seller, ticket broker, ticket brokers, ticket issuer, ticket and/or any other individuals or entities who or which utilize the apparatus and method of the present invention, particularly for generating an interactive seating chart. The user does not necessarily have to be the venue or event representative but can represent any user utilizing the present invention. As defined herein, the terms “end-user”, “consumer” or “buyer” refers to individuals that utilize the system after a seating chart has been created, for example to purchase or acquire a ticket or to view seating arrangements, availability, information, etc.

As defined herein, the phrase combining the term “seat” or “seating” with the term “chart” or “plan” refers to the digital visual representation of a venue (i.e., “map”), particularly to seats and/or sections within a venue that may or may not have additional information associated with each seat/section such as pricing, location, identity, seating details (e.g., section, row, seat, comments), designations (reserved, general, handicapped, etc.), and the like. The visual representation can be in the form of a schematic, outline, drawing or other representation to enable viewers to see the layout of a venue and the components thereof, preferably electronically, such as structures, landmarks (which may be structural landmarks, such as walls, columns, doorways, seats, and/or may be active or passive beacons, such as coded signs (e.g., where each sign has a unique visual code and the signs are strategically placed are columns, walls, etc.), etc.), or such other representation desired by the user creator.

Further aspects and advantages of various embodiments will become more readily appreciated and better understood by the following description of the elements of the communications system 100 illustrated in FIG. 1. Although certain exemplary embodiments and implementations may be illustrated and described as comprising a particular combination of elements and performing a particular set of operations, it is to be understood that the principles and techniques discussed herein are not limited to such examples.

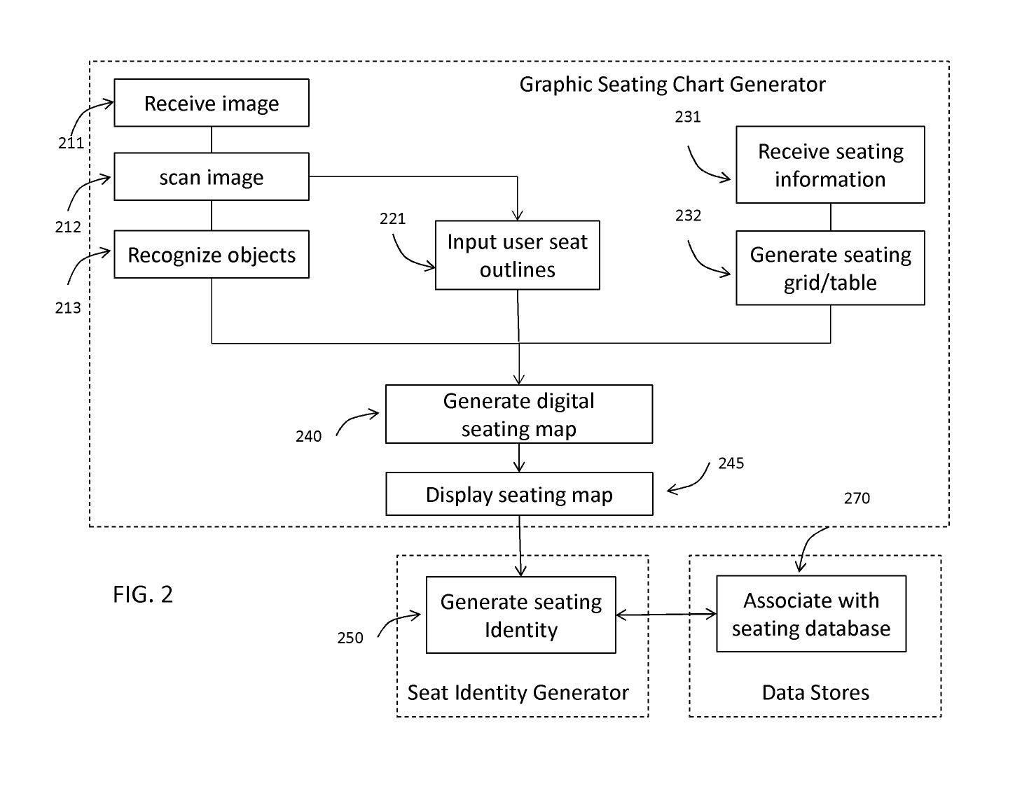

FIG. 2 illustrates the flow diagram of an example method for generating dynamic seating charts, comprising the step of generating a digital seating map 110 to visually arrange the venue, sections and/or seats. The schematic can digitally display the venue, sections and/or seats. The digital representation (e.g., digital map) of the seats can be generated graphically, manually drawn or input, or automatically. For example, in one method, a user can simply upload an image 211 such as schematics or pictures or representations into system, scanned for particular objects 212 using map-generating software to create a digital chart. Objects within the image can be automatically recognized using object recognition means 213, including those described herein, or alternatively, or in addition, a user/creator can manually overlay 221 an outline of the seat schematics 222, preferably through a preset drawing program with assigned shapes and characters for venues and sections (e.g., outlines), seats, tables, chairs, handicapped seating, reserved seating, large chairs, general seating, walls, columns, viewing obstructions, rooms, landmarks, and other features and designations. User/creator can use a photo, schematic or drawing of venue as background to overlay each of the shapes. Alternatively, or in addition, a user/creator can generate a seating framework 232 using templates and/or grids and tables 231. A digital schematic 240 of the venue, sections and/or seats can be generated and displayed electronically 245 for further manipulation by the system and user. System will generate identities 250 for each seat (specifically and/or generally), with the input of user. Additional information such as pricing, location, designations and other such details can be associated with specific sections and/or seats. Additional information can be stored in a database 270. Any seating map of the venue, sections and individual seat can be made and displayed to the user, with any modifications to the overview being digitally made to correct for any inaccuracies, changes, upgrades, additions or subtractions.

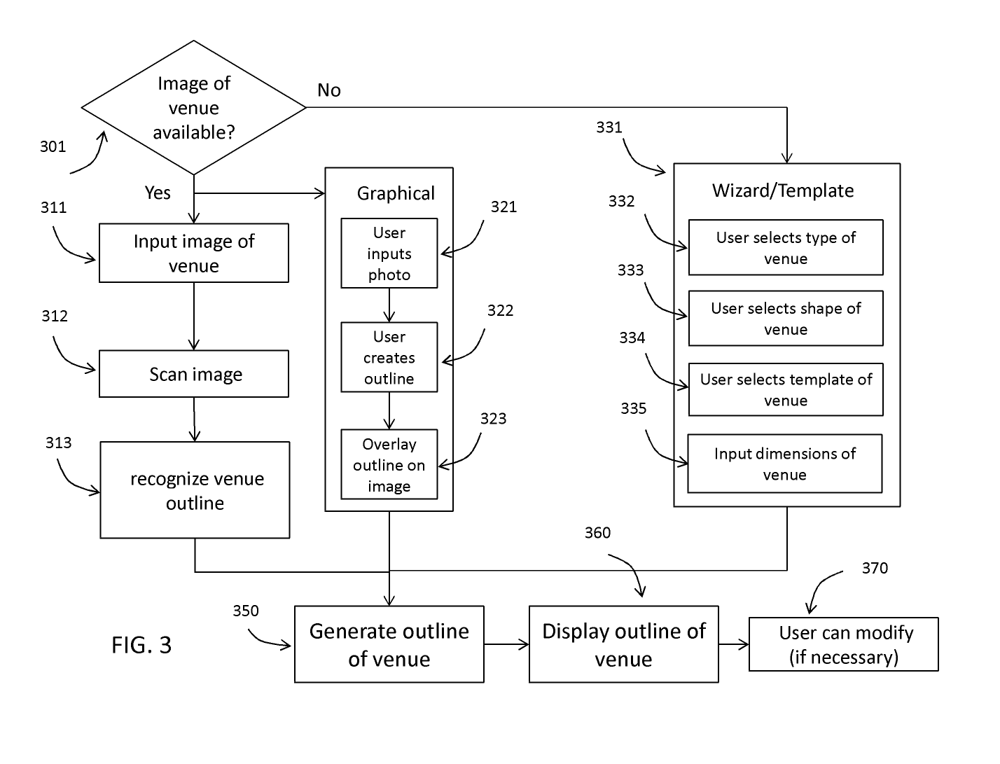

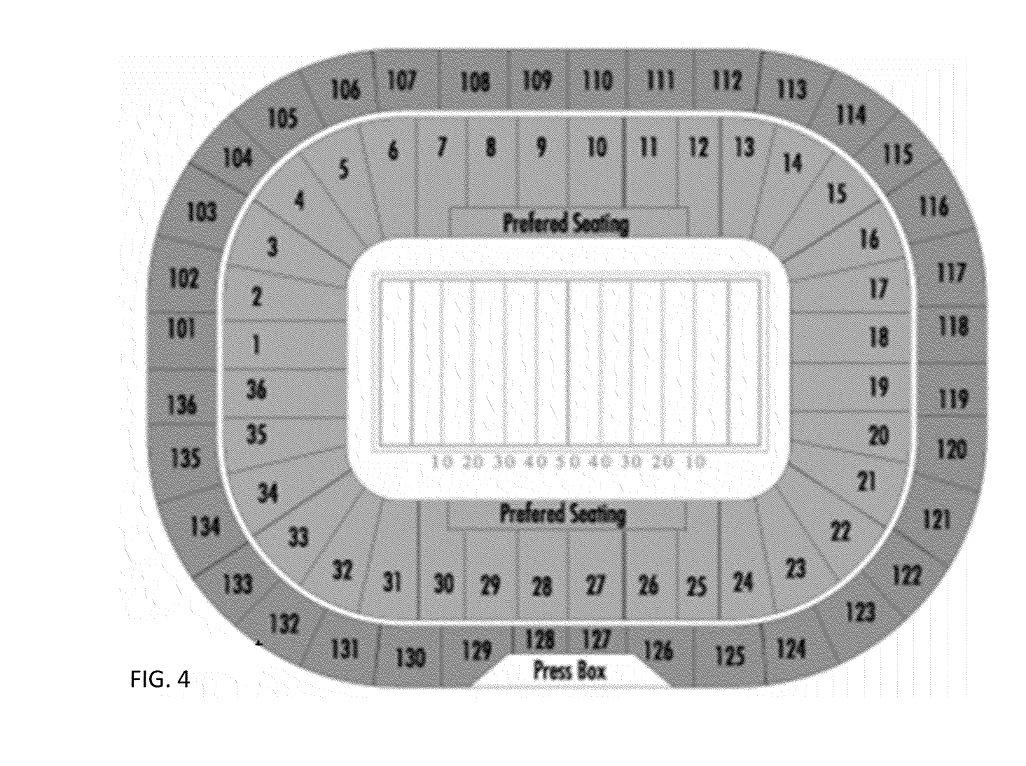

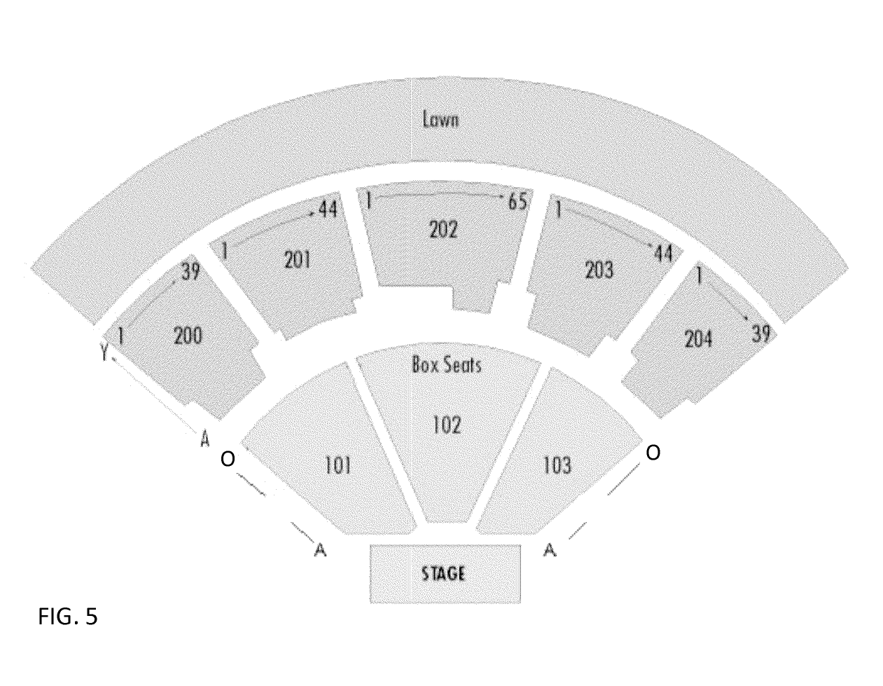

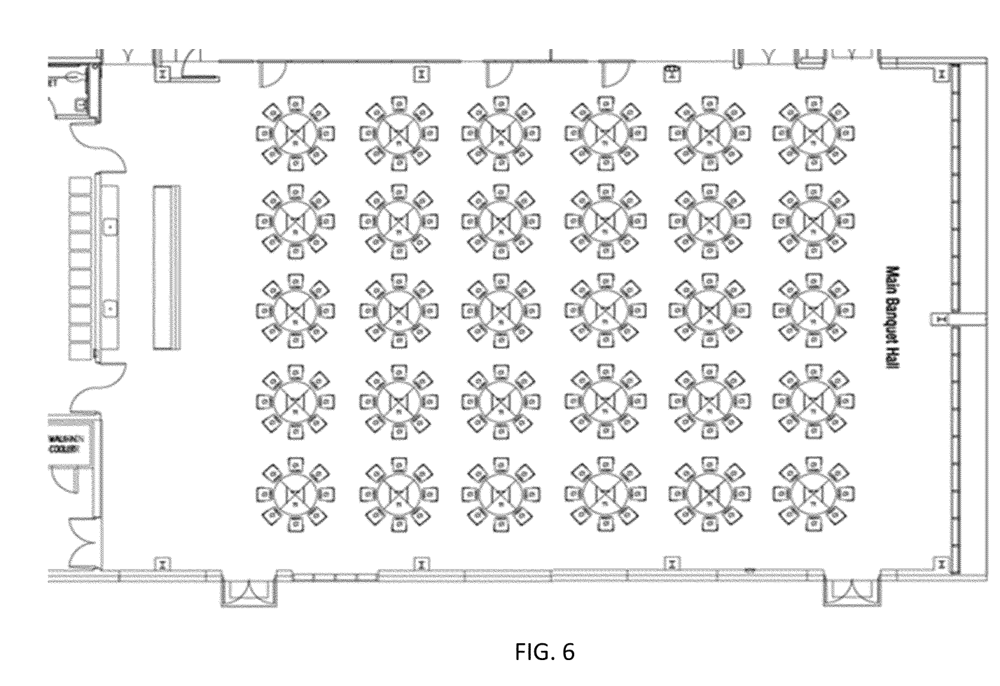

FIG. 3 illustrates the flow diagram for creating an outline of a venue. The seating chart of most venues will be determined by the general shape of the venue, whether a stadium, theater or room. If an image or schematic of a venue is available 301, such as shown in FIG. 4 (stadium), FIG. 5 (theater) and FIG. 6 (ballroom), the outline of the venue can be generated using object recognition software. The user of the system can input a drawing, schematic or image of the venue 311, which can be scanned 312 to create a digital layout of the venue. Alternatively, an image such as a picture of the venue can be input into system 311, scanned 312, and used as the background for the general layout. Object recognition software can be utilized to identify the boundaries of the venue 313. The present method can also advantageously use or be combined with satellite images, particularly large open arenas, to generate and depict a property overview outline of the venue.

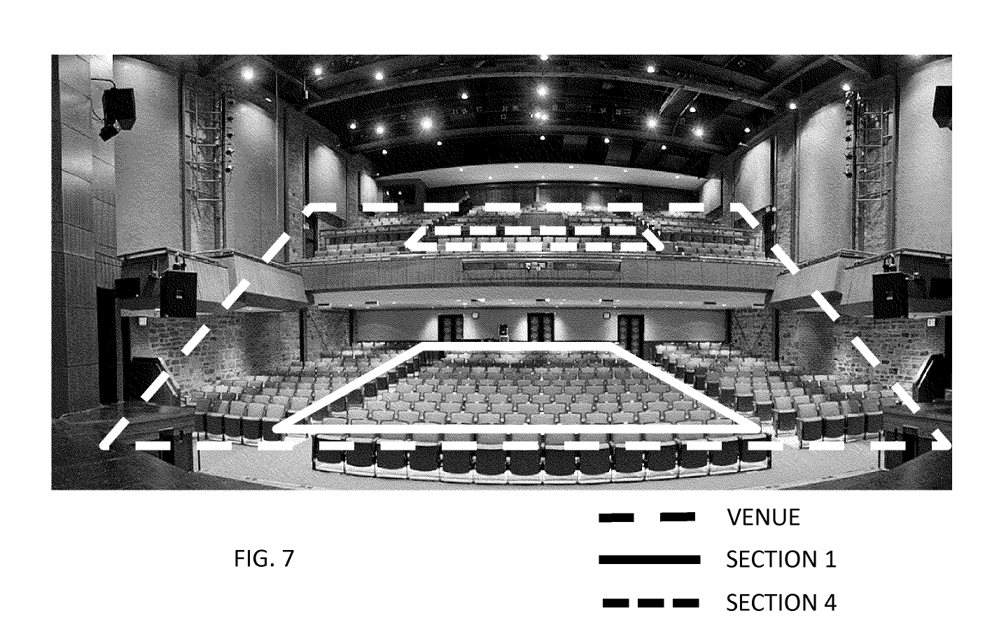

It may be advantageous to create a layout overlay that sits on top of a photo, for example one or more digital photos taken from a mobile device or camera. The photo can be input into system, or can reside on the user device. Once a photo is taken, an outline of the venue can be created by superimposing an outline over the photo of the venue. The creation of the digital overlay can be created on the device or on a server connected to the device. If the photo or schematic is used as the background for display to a customer, the system can create tags or marks on both the image and the overlay to ensure that they are consistently and accurately superimposed. FIG. 7 is a photo of a theater with an outline overlay of the entire seating area for the venue. The shape of the outline can be created by identifying the boundaries of the venue, for example, by identifying the corners of the image—with the boundaries automatically generated by connecting each corner, or by using pre-determined shapes such as squares, rectangles, trapezoid or other quadrilateral shape, circular or oval, triangular, etc. which can be “click(ed) and drag(ged)” and reshaped to fit the boundaries of the venue. A default shape can also be established for example an oval or quadrilateral shape that can be clicked and dragged to set the boundaries.

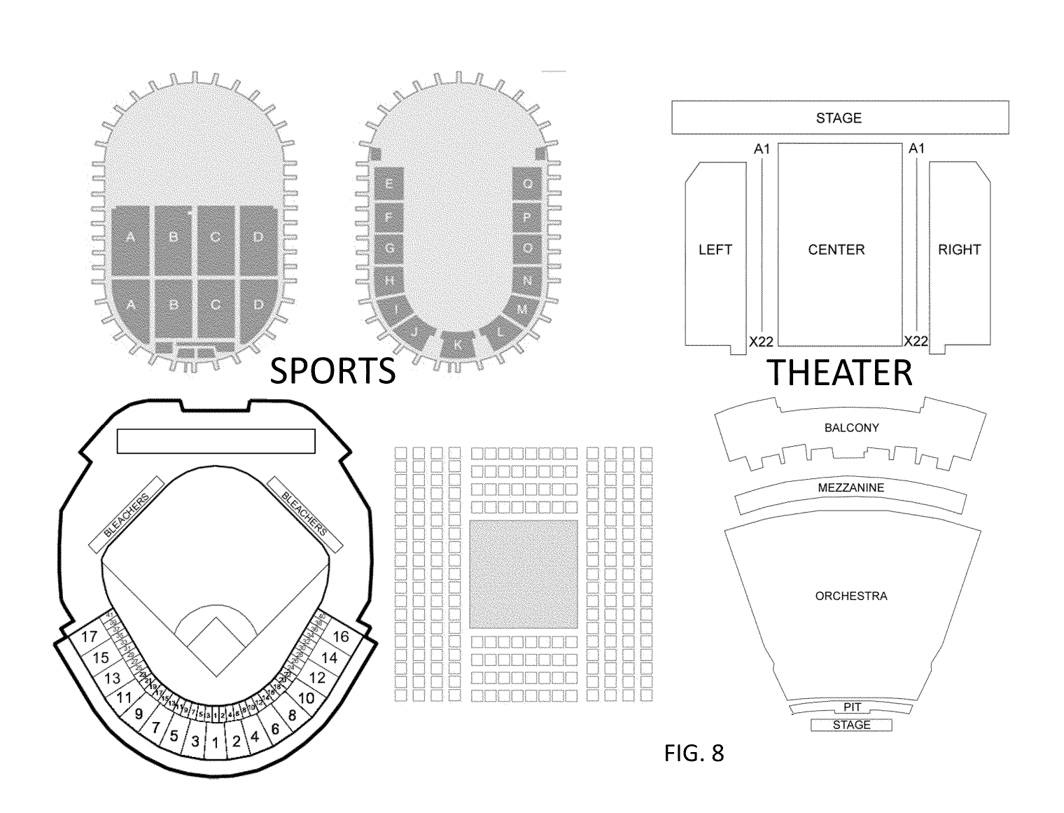

Outlines of the venue can also be generated by wizards and templates that guide the user through generation of an outline. For example, as shown in FIG. 8, user can choose between several templates. User can be prompted to identify type of venue, for example, a sporting event or a theater, more specifically, the type of sporting event such as football, boxing, basketball, baseball, Olympics, and the like, or the type of theater such as opera or dance, etc., which can be represented by text (preferably through a pull-down menu) or visually such as a template (e.g., within a user-interface window). User can also be prompted to identify the general shape of the venue, such as an oval for a stadium or an arc or quadrilateral shape for a theater, and the like. Alternatively, or in addition, the user can manually input the dimensions of the venue to more accurately depict the shape of the venue. The system will generate a digital outline that depicts the general or specific boundaries of the venue. This outline can be used within the actual seating chart and displayed to the end-user customer or be used to generally demarcate the boundaries of the venue to guide the generation of the sections outline and/or seat map.

Although the process of outlining the boundaries of the venue will assist the user in generating the seating map, it is not necessarily required as the boundaries of the venue can be established by the generation of the sections and seats as shown in FIGS. 5 and 6, 20 and 21.

Venues can typically be rearranged between different types of events, such as between sporting events and concert events. For example, a sporting event may call for all seats to be available in the stands and no seats available on the field, while a concert event may fill the floor of the arena with seats and kill or otherwise restrict from sale seats behind a stage. Some sporting events have different seating layouts than others. For example, basketball, which features seats near the ground and close to the action, typically has a different seating arrangement than football, which features seats farther away from the field. Some events, such as soccer and football, may have equal seating arrangements. Likewise, different concerts and entertainment events may have similar or different layouts, depending on the artists involved, types of performance, or types of production. Seating layouts may be predetermined by the promoter, venue, or artist, or the seating layout may be determined in conjunction with pricing.

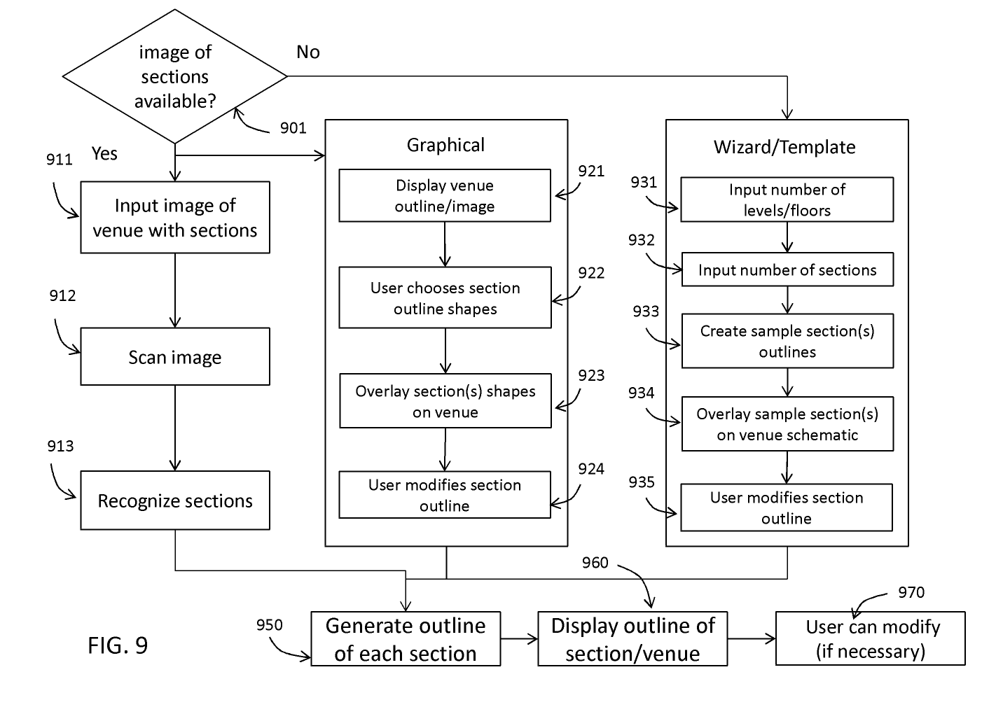

FIG. 9 shows the flow diagram for creating the sections of a venue, if any. The sections of a venue may demarcate the different sectors, sections, divisions, or sub-parcels of the venue that may be distinguishable from other sections by different features. Such features may be due to physical properties of the venue such as position or floors, pricing, physical boundaries such as walkways and stairways and hallways, demarcations such as reserved, preferred, VIP or general seating, reserved or other demarcation, access such as disabled seating, or such other separation or segmentation that may be necessary for demarcating a section, or combinations thereof. For example, a venue with multiple floors may have a center, left and right section on multiple floors, each section which may have different pricing. Similar to the venue outline, the section outline may be used as a general outline for representation and generation of a visual seating chart but not for actual display itself, or used for demarcating pricing or other such features. Preferably, as discussed further below, the sections can be tagged or marked by the system or the user to identify distinct sections.

Preferably, if an image or schematic of a venue with sections is available, such as shown in FIG. 4 (stadium) and FIG. 5 (theater), the outline of the sections can be generated using object recognition software. Object recognition software can be used to find the boundaries of different sections of an image, for example the outer edge of seats in a section, walkways or different floors, to create a digital outline of the sections in a venue. The system can recognize the boundaries of the sections and create a digital outline of the section akin to the sections in the schematic. The digital representation of the section can be displayed as an overlay to the schematic of the venue, which can be used a foundation for an interactive seating map. The image can be of the venue or of sections within the venue. Markers (e.g., symbols or other markers may be placed on image (e.g., corners or boundaries) to facilitate the recognition of boundaries for the sections. Any image of the venue can be input including photos (for example, ones taken by mobile devices, etc.), schematics, drawing or other representations. A digital outline is generated to overlay the accurate or approximate boundaries of the venue. Once generated, the digital outlines can be displayed and modified by user.

As further shown in FIG. 7, an image can also be used without object recognition. An image can be used as a background template to create a digital overlay. In FIG. 7 trapezoid sections are overlaid over an image of a theater; specifically in this image are two sections on different sections on different floors. The sections can be auto-generated (if using recognition) or manually created by the user. A user palette of pre-determined shapes, symbols and figures can be used to “click and drag” to create a digital representation of the sections, and altered to fit the outline of the section.

Alternatively, the wizard/template can be further used to auto-generate the number of sections. In one embodiment, this step is a single process in combination with the wizard/template for the seating and/or venue. However, this process can be initiated at any point, including for generating the individual seating chart or, in this case, the section generation. The wizard can request specific information be provided by the user to create a section chart, including, for example, the number of floors/tiers/layers, the number of sections in that floor, and other such parameters to create distinct sections. For example, in a stadium with two layers, each layer may have 20 sections that circumnavigate the circumference of the stadium. The user may input the number of layers (2) and input the number of sections in each layer (20), which will be displayed as two oval rings with 20 sectors within each ring. Each sector may not accurately reflect the true size of each section, but can be modified by the user to more accurately reflect the true physical layout of the venue and sections. Each section can be digitally identified with numbers, characters and/or symbols to distinguish each section from other sections.

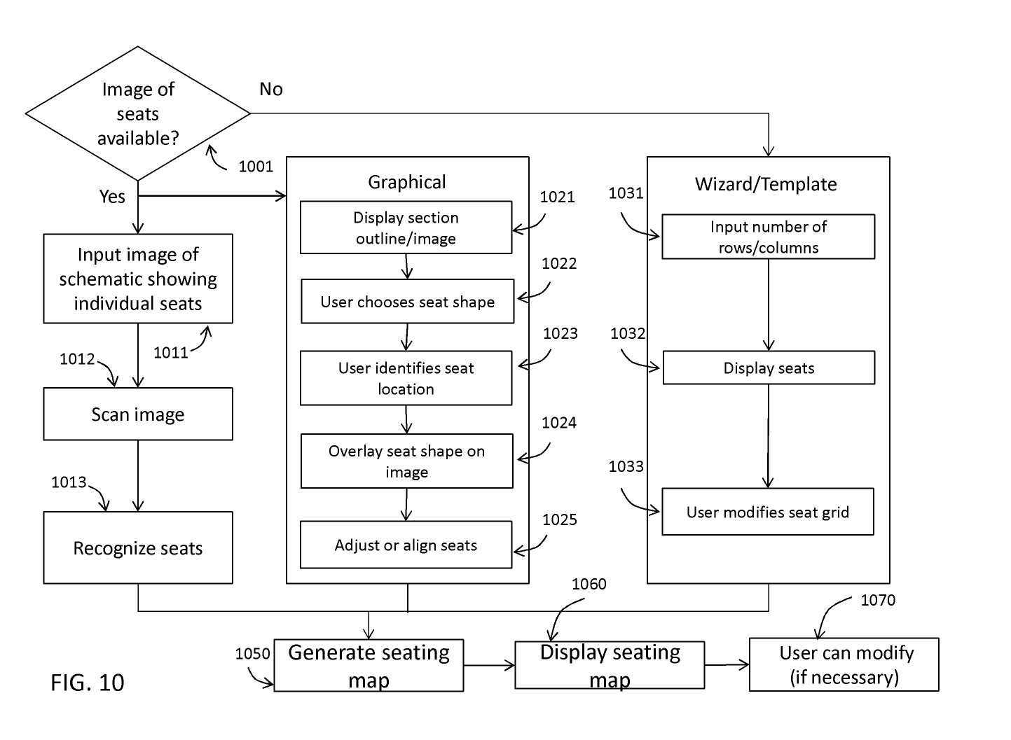

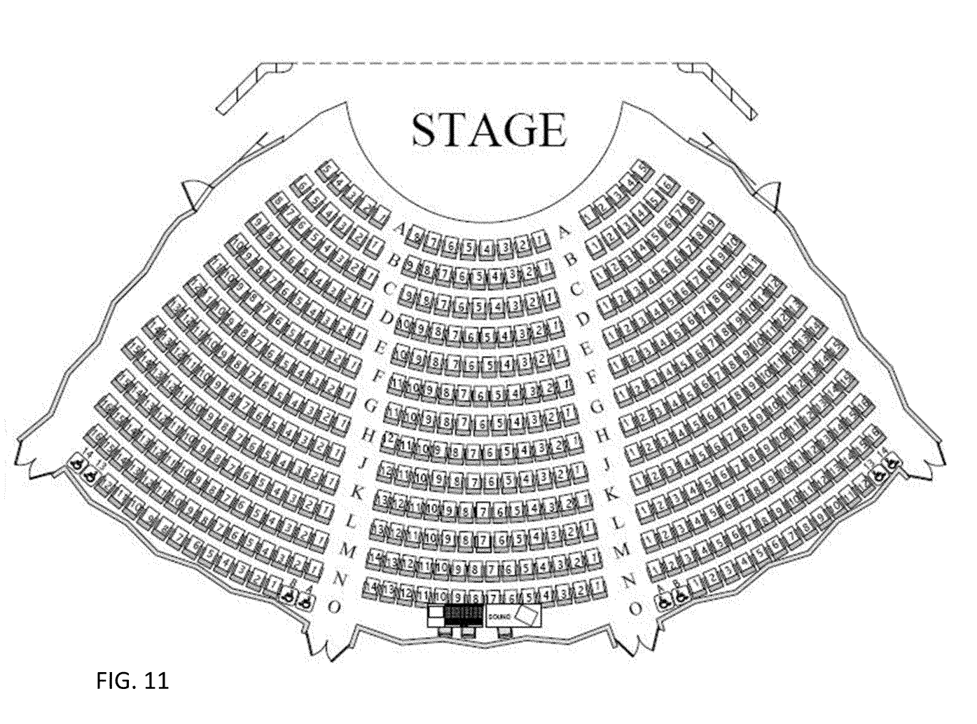

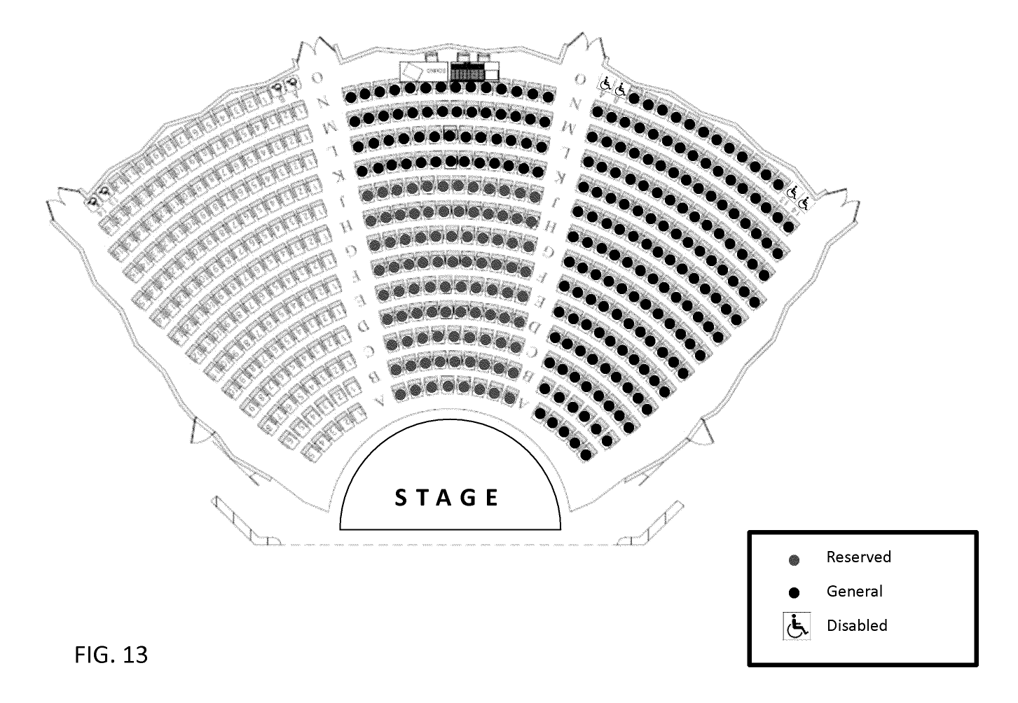

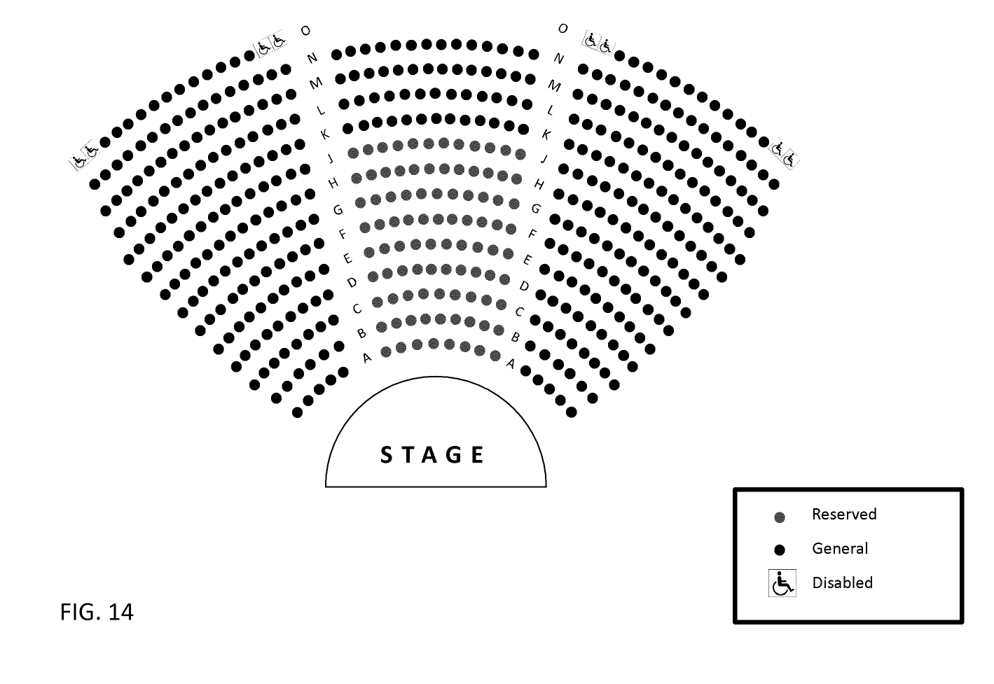

FIG. 10 shows a flow diagram for the generation of an interactive digital seating map for individual seats. If the user does not need to identify individual seats for their intended purpose, e.g., seating assignment, ticketing or reservation, the generation of the sections may be sufficient (e.g., general seating). The user can create the seats one at a time, row-by-row, section-by-section, in multiple sections such as a floor or by designation (e.g., reserved seatings), or for the entire venue. This process enables a user to quickly and more directly make changes and/or modifications to the digital seating map in parallel with near real-time changes to the venue. To the customer end-user, the digital seats can be visible (e.g., shapes), transparent or invisible (such as FIG. 11), and utilized together with or without a background image. For example, as shown in FIGS. 11, 13 and 14, when a satisfactory schematic exists (FIG. 11), the end-user customer can interact directly with the input image (FIG. 13) to create a graphic seating map (FIG. 14).

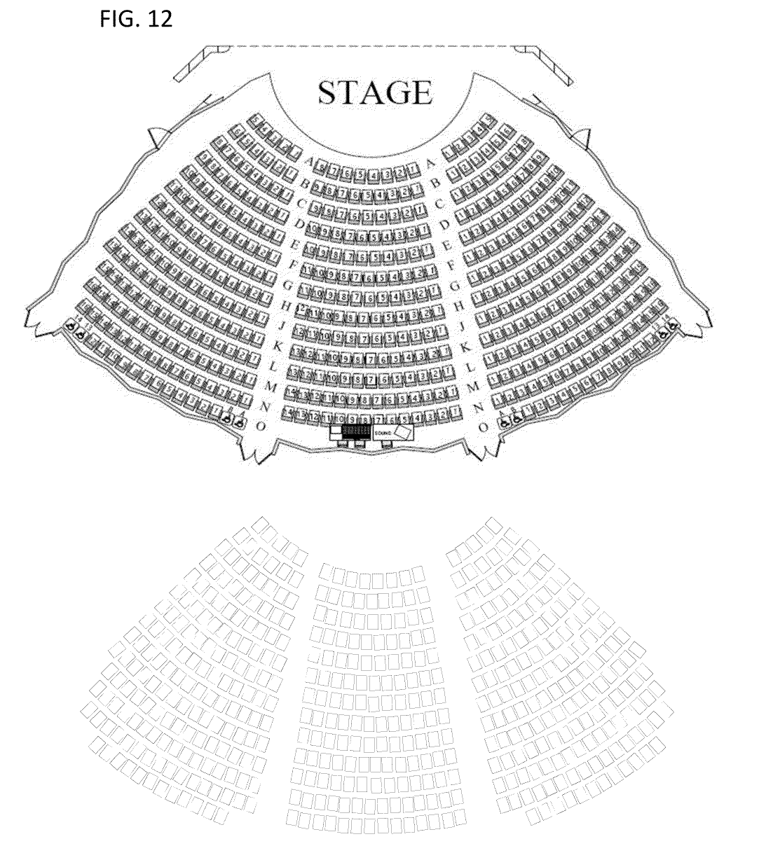

Preferably, if an image or schematic of a seating chart is available, such as shown in FIGS. 7 (picture) and 11 (schematic), a digital seating map 1050 can be generated using object recognition software. The user can input an image 1011 having visible seats that are presented as an image or as a schematic. The input image is then scanned 1012 into the system and then the system can recognize seats 1013 such as shown in FIG. 7 (e.g., by identifying seats or chairs based on automated pattern recognition or through training of the system by user's input of exemplary seats) or as shown in FIG. 11 (e.g., by identifying the shapes and/or outlines of the seats through object or border recognition techniques), or by such other method known to those of skill in the art particularly to those in the art of object recognition. For example, in an illustration such as shown in FIG. 11, the system would identify and demarcate squares as individual seats. A digital seating map, see FIG. 12 can be generated and then superimposed over the schematic. Any corrections to the digital seating map can be made at any time by the user. Any image of the venue, sections or seats can be input including photos (for example, ones taken by mobile devices, etc.), schematics, drawing or other representations.

The overview image can also be linked to numerous digital images, such as digital photographs, of rooms in a structure, exterior views of a structure within a property, and outside spaces and outside structures within the property, using icons placed in the property overview image. The present method is advantageous due to its unique compilation of information. Simultaneous with the outline generation process, various features, amenities, benefits, characteristics, qualities, and materials of a property can be recorded such as viewing obstructions, segmentations or other interruptions, etc.; and graphic images reflecting these features can be drawn and inserted into the overview image. Unlike many conventional floor plans, the present method produces overview images that also can include annotated text information relating to features of a room, outside space, or outside structure displayed in the overview image. Extensive textual annotation describing measurements, landmarks, fixtures, textures, materials, columns or overhangs, ceiling, flooring, and various other features can be included in the overview image.

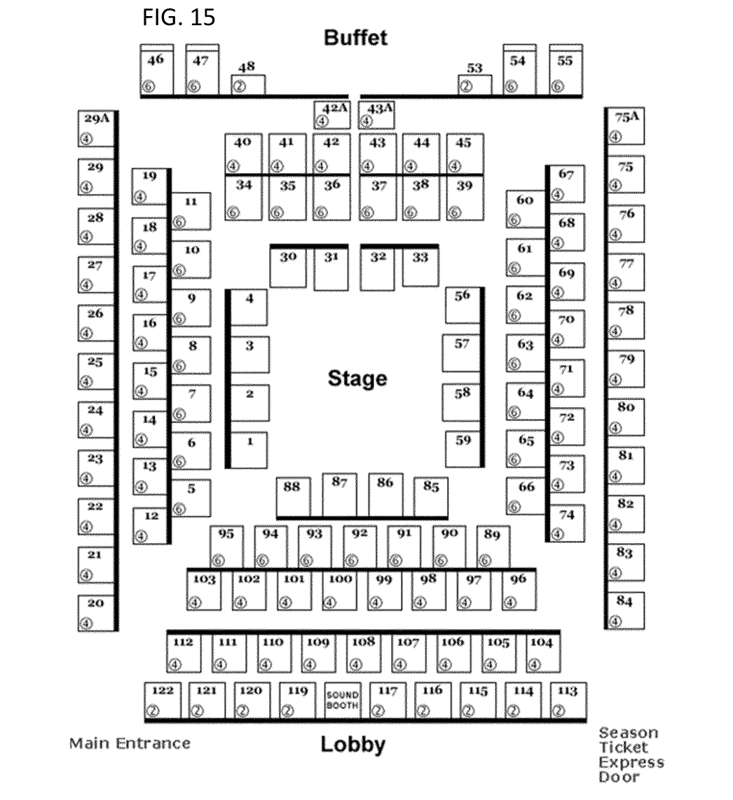

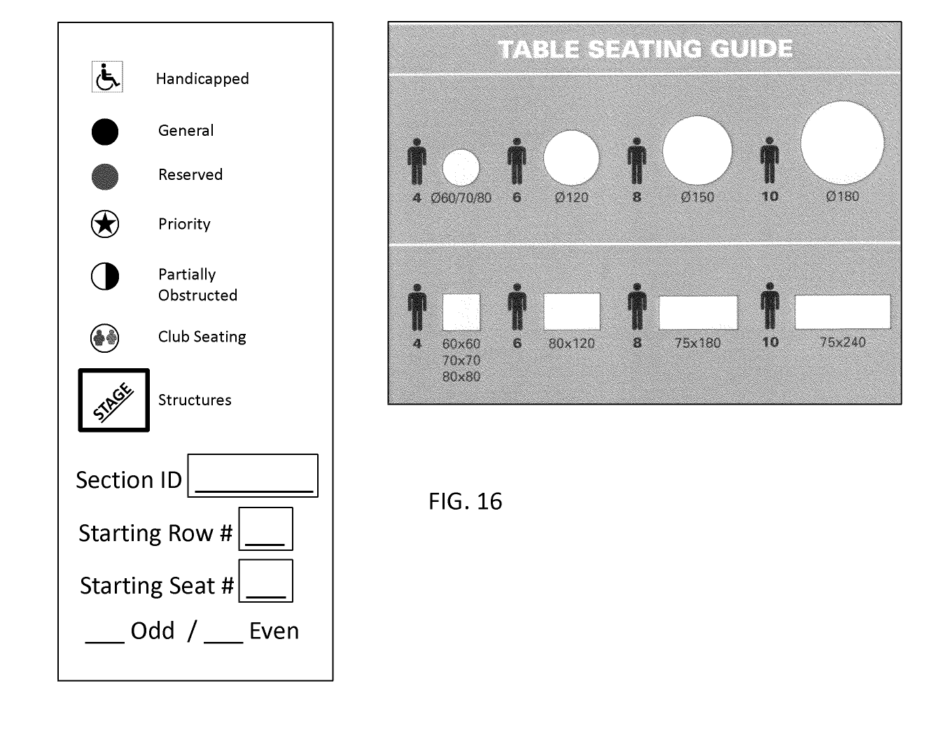

Alternatively, images or schematics as shown in FIG. 7 or 11, can be used as the background for generating a digital seating map of the venue without object recognition. The image, photo or schematic 1001 can be used as the background 1021 and the user can create a digital overlay 1024 of seats over the background image. For example, a user palette, see FIG. 13, of pre-determined shapes, symbols and/or figures 1022 can be used to “click and drag”, “copy and paste”, “drag and drop”, or digitally overlay the shapes/symbols/figures over the sections/seats on the background. FIG. 13 shows different shaded/colored dots to represent different types of seats, reserved and general orchestra seating, as well as disabled seating in the back. These shapes are overlaid on top the schematic, and can be shown together with (FIG. 13) or independent of (FIG. 14) the original input image (FIG. 11). Seats can be clicked and dragged to the proper position 1023, chosen and paste onto the proper location, or “copy and paste”-ed in bulk based on symmetrical spacing. Any corrections to the digital seating map can be made at any time 1025. This flow is shown in FIGS. 11, 13 and 14. FIG. 11 shows an input schematic, FIG. 13 shows a digital seats superimposed over a background image of seats, and FIG. 14 shows the digital seating map independent of the background. The digital seating map can be further processed by the system to create identities for each seat, and then associated with a seat database or other database. Similarly, a room of tables can be created using a schematic of a ballroom with tables as the background, such as shown in FIG. 15. It should be recognized that tables can be substituted for individual chairs, and the user can be presented with multiple or a variety of window palettes (FIG. 16) to create the proper seating map.

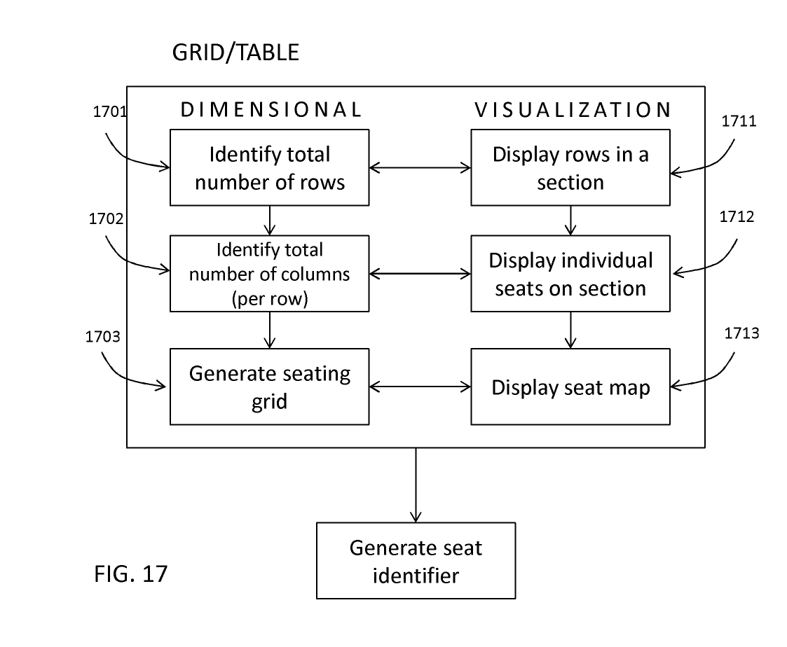

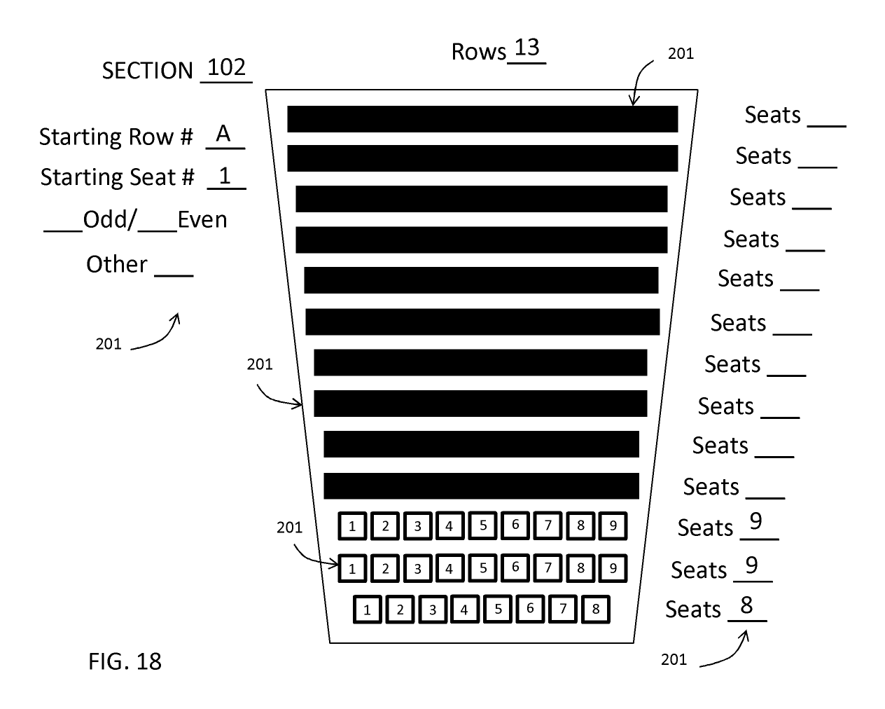

As further shown in FIG. 10, a user can automatically generate a seating chart using the present invention. In an embodiment, a wizard can generate a seating chart section-by-section without graphic input. A user can input information about the seating arrangements, which can be translated and displayed as a grid of seats for the user to manipulate. FIG. 17 provides an exemplary flow process for a wizard to input dimensional information to generate a visual map of a seating grid. Alternate flows of the same process are also contemplated, for example, inputting the seats and rows simultaneously in varying sequential order. Preferably, the dimensions are based on the number of seats in rows and columns, or measurements such as meters and feet, with seats and spacing measuring certain dimensions. The information can be input manually or automatically, for example, through audio (voice) inputs. FIG. 18 shows the generation of a digital grid. A visual map can be generated in parallel with the digital grid to facilitate the use of the system by a user. Generally, a seating chart is a grid of seats that comprise a row of seats that may or may not be arranged in columns (seats may be in-line or off-set). System preferably requests user to input capacity of seating arrangement, for example number of rows and number of columns. In an embodiment, user is prompted to input the total number of rows in that section or in the venue (depending on whether the user is working section-by-section or the entire venue). Once the number of rows is identified, system may display the number of rows as shown in FIG. 18. The user then may be requested to input the total number of seats in that row. If the seating is in benches, the approximate number of seats may be sufficient to approximate length of row. If the number of seats is consistent for several rows, then the seats can be input as columns. For example, a section may have 20 rows of seats each consisting of 10 seats, which can be input as 20 rows by 10 columns, to display 200 seats. Each row can be input separately as well, particularly if the section has differing number of seats in each row (as shown in FIG. 18). Once completed, the system can generate a digital seating map that can be displayed and manipulated.

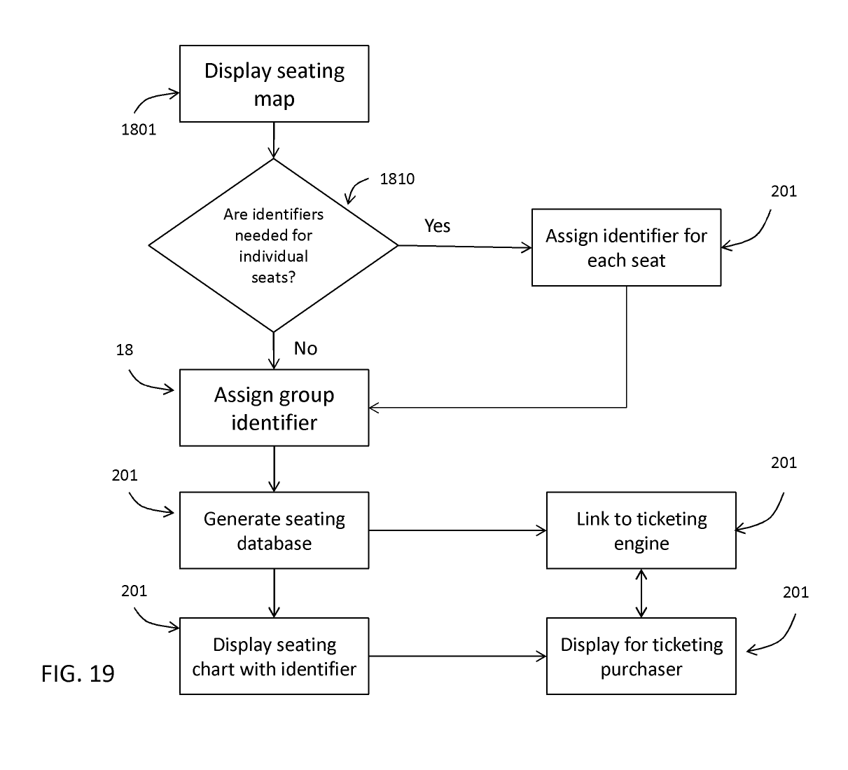

FIG. 19 shows an example of a flow for a seating identity generator. Once a digital seating map is generated, identity generator will designate and associate each seat with an identity. There may be more than one identity for the seat, for example, the identity displayed to the end-user to visualize the seat and one that is used internally by the system to uniquely identify the seat. The identity of the seat is generally its location within the venue, the section and amongst other seats, e.g., the row and seat number (aka column), although other designations are contemplated such as numbers, codes and coordinates. For example, a GPS coordinate may be used to identify each seat. The identity of the seats can be done in bulk, in sections or sectors, or individually. For example, a section of seats may be designated as general seating. Preferably, an inventory of the total number of seats available in a section, and more broadly, within the venue, will be accounted for.

Each section can be processed separately to make management of the different seats easier, particularly if there are multiple sections. Or, alternatively, the identification can be generated for the entire venue, or multiple sections at a time. Generation of the identifier for the section of seats can be in conjunction with, separate or in lieu of the generation of the individual seat identifier. Preferably, the system will begin by creating a default identifier for the section, for example theaters have orchestra as the lowest level, followed by the higher levels of ‘loge’, ‘mezzanine’, ‘grand tier’, ‘balcony’ and ‘gallery’, respectively. Stadiums are often numbered with each levels numbered indifferent sequences, e.g., 100s, 200s, etc. Generally, however, section identification will be unique to the user and the venue and may require direct input by the user, as they may distinguish each section, e.g., ‘grand circle’, ‘reserved’, ‘general’, ‘left’, ‘right’, ‘center’, ‘upper’, ‘lower’, ‘field’, ‘box’, ‘club’, or other such distinguishing nomenclature. The names used by the system may be different than the names displayed for easier management of seats.

If individual seat identity is necessary, system may create seat identity(ies) automatically. For example, if the seating information is available in a schematic, text recognition can be applied to identify the identity of the row and of each seat. The schematic in FIG. 11 shows the row number and the seat number for each seat, which can be recognized and input into the system. Alternatively, the system may prompt user for information about the identity for each section, row and seat. Additional identity information may include whether seats are identified by alphabetic, numerical, or other descriptors, or section identification (such as section number), section title (such as “Lower Box”, “Field Club”), and the like.

Seat location within a section is generally identified by its row number, although it can be identified by its table number, box number, section number and the like. As discussed, this information can be manually input by user, automatically prompted by system or something in between. For example in FIG. 18, for a seating chart with 13 rows and varying number of seats across each row, the system will provide user with a template to generate the seating identity with as little input as possible by user. The default identifier rule may be to number the rows from front to back ‘A’ through ‘Z’, and double letters thereafter (e.g., ‘AA’, ‘BB’, ‘CC’, etc.). User can override the automatic numbering, for example, reversing the order (e.g., back to front), using a different beginning letter or prompting the system to use numbers, or other identification rules as shown in FIG. 14, where the letter ‘I’ is skipped/removed going from ‘H’ directly to ‘J’.

Similarly, numbering of each seat across each row can also be prompted by the system or input by the user, but preferably defaulted to start from 1 through N (N=the last number of the seats). User can override system to either start with different numbers, letters, codes or other identifier, as well as use coding sequences unique to that venue (e.g., odd or even numbers for different sections of seating). FIG. 18 illustrates the prompts for user to input the section, beginning row and seat number, as well as other rules such as odd/even numbering of seats. Alternatively, unique identifiers may not be necessary to enable the user to create bulk types of seating, e.g., general, reserved, different sections, etc. that are not associated with individual seats.

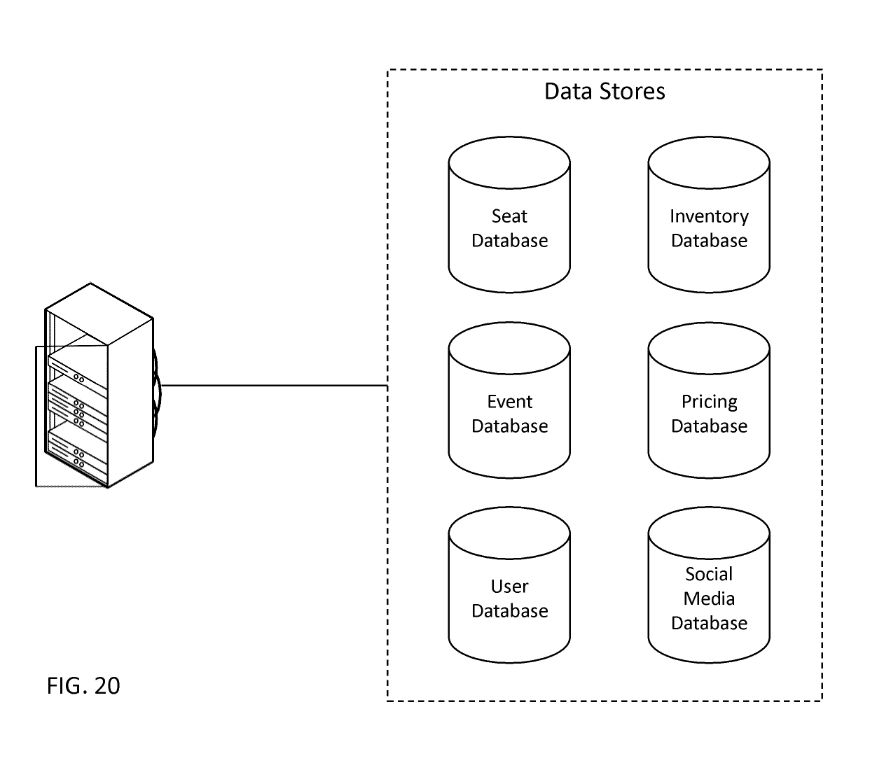

As shown in FIG. 19, the information created from the seat identity generator can be used to access data from and store data to one or more data stores (see FIG. 20, e.g., event database, seat database, pricing database, ticketing or inventory database, user account database, social network database, etc.). Data stores (e.g., databases) may be used to store some or all of the information discussed herein (e.g., seating chart/maps, pricing information, seat status, purchase information, ticket information, etc.). The data stores can be accessed within the system or without the system in one or more separate locations. This information can be correlated with the data stores to visually display ticketing/registration/reservation and seating availability.

FIG. 19 illustrates an embodiment of the system that incorporates a seat map for the venue where an event will take place. This system includes a descriptor for each seat in the venue comprised of variables that uniquely identify that seat (e.g., venue, section, row, and seat number). The system also includes a means for ascribing additional information stored on the databases such as price to each of the seats. The system integrates this information with the seat map information and renders a dynamic seating chart which can be correlated to seating information, price and inventory, particularly for such uses as ticketing and reservations.

In a further embodiment, system can correlate current seat inventory information with the event database to show existing inventory for a particular event. The inventory information may be uploaded or the system may have a direct connection to an inventory database. This allows the inventory to be displayed visually by status (e.g., available, sold, held, unavailable, reserved, inquiry), by price (e.g., the face value of the ticket for a particular seat, or the going price for a particular seat), and by class (e.g., the type of ticket associated with the seat, the type of package associated with the seat).

As shown in FIG. 20, seat database may provide information about each seat such as the venue, the section, row, seat number, seat identification number, the aggregates of such numbers such as seats available, geo-location, and similar information. Other information, such as whether the seat has special viewing or obstructed viewing, is in a covered area or an exposed area, in the shade or in direct sunlight, the distance of the seat to an exit, bathroom, concessions, parking lot, and/or other destination, how far the seat is from an aisle (e.g., expressed as a number of seats and/or in a unit of length, such as feet, meters, or yards), expected temperature at the seat during the event, within smoking or non-smoking area, in a private area such as box seating, and/or other information may be displayed as well.

Designation or characteristic information can also be attributed for each seat which may be temporary or permanent designations such as accessibility by handicapped or disabled individuals, adult or child seating, smoking or non-smoking, box seating, accessibility (e.g., privileged, special or general), amenities available such as food or alcohol and other services, reserved or general seating, VIP, season seats, box or held seats, and other designations provided for particular (types of) seats.

Specific information about the seats, by way of example and not limitation, seat shape and color, seat type (e.g., bench, cushioned, non-cushioned, back rest, no back rest, etc.), seat material (e.g., concrete, wood, plastic, etc.) and/or seat rotation angle may also be included and displayed. Information may be conveyed via a seat icon (or other indicator) using a corresponding interior color, outline color, interior symbol/text/character, color of such symbol, one or more orbiting symbols that are optionally color coded, etc.

More preferably, user can define sectors or zones to identify similar seating areas, particularly for pricing. Sectors or zones can be based on sections, rows, or blocks of individual seats that are similar in location, feature, but more preferably price. Different sectors and zones may be defined for different types of events.

A database connected to or included in the invention system can also include the price or price type for each specific seat. The price may be the specific price, a range of prices or the category of prices. Fixed types of events, e.g., movies, may warrant fixed prices or prices within set ranges. User can set the price through the system for all seats, sections or zones, or for the entire venue. However, it may be advantageous to use aggregate seats/sections based on location and/or designation to account for different types of events which each may attract different prices, for example a stadium which holds both concerts and sporting events will have two different prices for the same seat or same section, or may categorize different seats based on different identifiers.

System can allow the user to assign prices to seats by creating a certain number of ‘price codes’ or price levels that relate to dollar values. The system extracts seat information from a seat chart/map by defining different zones. Zones can be preset by the user or modified based on the input of event organizers, promoters and the like. The user is prompted to assign price codes to each zone, and the dollar value for the price code is associated with each zone. The dollar value of a price code can be changed centrally, and such changes will update the price for every seat identified as being part of that price code. The user can also enable price codes to be defined by third party users such as event organizers, promoters, artists, venue or other interested party that may assign pricing. The user can also set aside seats, make unavailable or create other pools of tickets for a particular. For example, seats with obstructed views can be color-coded or X'ed out so that it is immediately clear to the user that the seats should not be listed for sale. The user may also indicate that certain seats are to be ‘held’ (i.e., hold them from an initial sale period). The user can preview a visual representation of the pricing plan to make sure that the locations by price and the overall financial potential of all tickets (if sold) meet the needs of those involved with the event.

The user can export the price plan's price codes and seat block assignments to be imported into a ticketing system. If the pricing system is directly linked to the ticketing system, then the pricing information can be directly submitted to the ticketing database. The user can create several ‘price plans’ for an event to determine the best plan for each event.

Other differentiators that may affect price include the type of ticket (e.g., processing and other ticketing fees, adult-full price, adult-discounted, child, reserved or general, box seats or other viewing privileges, or alternatively obstructions, amenities such as dining or parking privileges, packaged such as season tickets, etc.) etc.), second market or resale or auction-able tickets, or other factors which may affect price such as excess or unwanted inventory (e.g., an indication as to whether the seating area only has single seats available and not two or more available adjacent seats).

In a particular embodiment, the system may be configured to obtain and/or provide information for active ticket listings and sold ticket listings to enable dynamic pricing for primary or secondary ticket sales. The information may comprise pricing information including active ticket prices (e.g., fixed, auction, and/or declining prices for unsold tickets) and sold ticket prices (e.g., actual prices fans have paid for specific locations) for providing an accurate representation of the current market value of tickets for an event. For each event, the pricing information may comprise data defining active listings (e.g., section, row, quantity, listed price) and sold listings (e.g., section, row, quantity, date, sold price) for each section and for each zone (e.g., aggregated sections) in an event venue.

The pricing information also may include data defining the highest price, the lowest price, and the average price for all active tickets and/or sold tickets within any section or zone. In some implementations, the average price may be calculated as a median price for all active and/or sold tickets within any section or zone by dropping the lowest and highest priced tickets. The pricing information may comprise data defining comparable sections, such as the top ten sections that are closest in price. The pricing information may further comprise the overall average ticket price for an event calculated, for example, by dropping the five lowest and highest priced tickets. The pricing information also may include rising and falling pricing trend information such as price change data (e.g., the percentage change in the average price of sold tickets for an event within the last N number of days), listing rate data (e.g., the percentage change in the amount of active listings within the past week, and/or selling rate data (e.g., the percentage change in the amount of sold tickets within the past week). It can be appreciated that other types of information and/or data may be obtained and/or provided in accordance with the described embodiments.

The system can further be uploaded with or be directly connected to an event database that provides information about each event at the venue. The event database can contain information about dates and times of different events; the main attraction such as the performer, movie, team, activity, organizer, host, guest of honor, or artist; genre; the number of expected attendees; the promoters or the organizers of the event; specific requirements of the event; and other such information related to the event itself. The user can utilize various tools that analyze sales rates of a given event and current and/or past comparable events to determine the likelihood that certain seats/sections/price levels may or may not sell out at the current set price, and to indicate whether price changes may or may not be recommended in order to sell out or to achieve other sales goals and/or whether certain events should be packaged together. This information can be used by create a pricing plan customized for a particular event.

Other information may be stored in the system database and included in or associated with the present invention. Depending on the use of the dynamic seating chart, e.g., ticketing, reservations, etc., additional information can also be accessed and stored, including end-user CRMs that manage identity and activity data for individuals who are or may be potential end-users, social media databases to enhance sales and marketing, public or private databases to extract historical and comparable data and templates to facilitate generation of new dynamic seating charts, and other data stores which may facilitate or enhance the use of the present invention.

Another embodiment of the present invention includes a system and method for correlating current seat inventory information with a dynamic seating chart of a venue. The inventory information may be uploaded or the system may have a direct connection to the inventory database. This allows the inventory to be displayed visually by status (e.g., available, sold, held, killed, inquiry), by price (e.g., the face value of the ticket for a particular seat), and by class (e.g., the type of hold, the type of package associated with the seat). This information from the database can be displayed on a seating map, along with other pertinent information utilized to enhance gross revenues, net revenues, and/or the number of seats filled/tickets sold. For example, the inventory provides a block of data for each section of the event venue or for each section of the event venue that has available tickets for the event, the block of data including section data such as a section identification (such as the section number), a section title (such as “Lower Box”, “Field Club”, or “Arcade”), and a listing of tickets (including the row, quantity, and price for each ticket). Certain embodiments may be utilized to reduce certain types of resale activity (e.g., resale activities that may not be in the public interest, such as, in certain instances, ticket scalping).

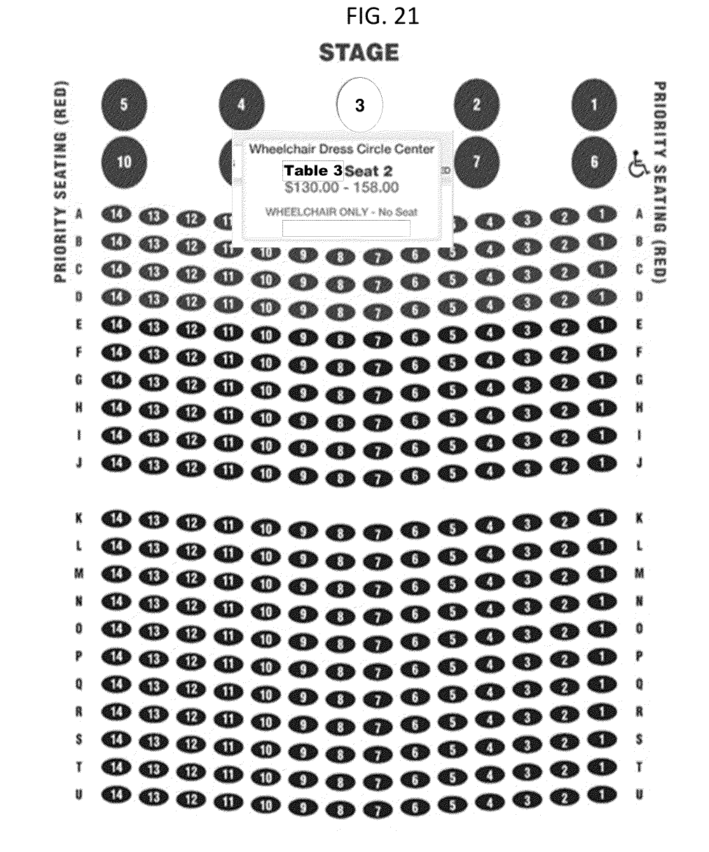

The interactive event venue seat chart, see FIG. 21, allows the seller to browse and click on sections to see sold and listed data for any section in the event venue. When presented with the interactive event venue seat map, the seller may roll over a particular section causing a roll-over screen to appear that includes the section name, the average sold price for tickets in the section, and the average listed price for tickets in the section. If the particular section is clicked and pricing information is available for the zone, the sold/active pop-up displays the section name and presents ticket details and transaction information for sold or active event listings within the section.

Controls are provided via which the user can navigate around the map and/or zoom into a certain section of the map. For example, the map is configured to enable a user to click on an area of a map and drag the map to change the displayed map area. In certain embodiments, even when a user clicks or otherwise selects a particular seating area or section, to thereby expand the view of the selected area, the entire venue is still displayed in an area of the map, with the seat statuses indicated (e.g., via color and/or text). The system may further provide user the option to search for different features. For example, if a user enters search criteria (e.g., seats having a ticket price between $50-$100), the user interface will highlight (e.g., via color coding or otherwise) the seats and/or sections that match the search criteria. If the user then selects a given highlighted section, the user interface will zoom in on the selected section, while still displaying an overall view of the venue (which may be reduced in size) in a corner or elsewhere, where the overall view still highlights the seats/sections matching the user's search criteria (e.g., seats between $50-$100). This enables the user to make changes to the dynamic seating chart more readily. The user can upload new price codes or make changes to the pricing of seating individually.

As illustrated in FIG. 21 the user interface may include a map that graphically (e.g., via a drawing or a photograph) represents a seating chart of the entire venue (optionally with various sections identified graphically, via color coding, and/or via alphanumeric text), and an expanded view of the venue showing individual seats, wherein the user can move a navigation box over the seating chart of the entire venue to select the area that should be shown in the expanded view. Optionally, corresponding colors are used to indicate seat status with respect to availability (e.g., available, sold, on hold, etc.), but not to indicate price, which may be shown textually. Optionally instead, corresponding colors are used to indicate seat ticket price.

When the display and visualization capabilities are used for planning or inventory control purposes, the seat status information or a data file can be modified, either manually or through system that allows the user to select seats on a seating chart. New information (e.g., price information) about those seats can be input, thereby updating the data file. This allows promoters, venue owners, or other stakeholders a relatively easy to use tool with which to try out different pricing and seating configurations before finalizing pricing for an event.

Further, the system receives substantially real time ticket sales information for one or more ongoing events, and reports the information to a user (e.g., reports an event ticket sales rate, the number of sold seats, the number of unsold seats, the number of held seats, the percentage of sold seats, a projected sell-out time, event web page visits, event web page conversions to sales, cumulative sales by day as a percent of original net capacity, cumulative audit gross by day, and/or other information discussed herein). The system also has access to, and is configured to provide for display historical information for events that have concluded, including some or all of the types of information provided for ongoing events.

The display and mapping capability can be accessed through desktop software or through a web and mobile-based applications. A web-based and mobile-based application can allow users not linked to the ticket data to visualize ticket information. This may be particularly valuable to concert promoters that wish to know about sales status but are not co-located with the ticket database. A web-based system allows users to log in from a remote location, enter a password, and view data. In the case of a user that has access to ticket data, this data is uploaded and the data from the file can be viewed in a number of displays. For a user who does have access to the ticket inventory database, the embodiment will present the last data that was uploaded by someone with access. It is also possible that the system is connected to the inventory database and information is updated automatically. There can also be different levels of access for different password holders, allowing each user access to a predetermined portion of the data.

The system optionally utilizes the event seating and ticket pricing information as an interface for display to end-users such as ticket purchasers. For example, the user interfaces may display a seating chart color coded, icon coded, and/or text coded to indicate seat availability, prices, seats selected by the user, seats purchased by the user, seats that match user search criteria (e.g., price range, seating section(s), seat type, special offer(s) specified by the user, etc.), other seats that are available, seats that are not available. Other features viewable may be wheelchair accessibility, whether a special code is needed to purchase ticket for a seat, whether the user has already purchased a ticket for the seat for the event, etc. The ticket purchaser user interface may provide a control via which the user can specify filtering criteria (e.g., ticket price, viewing quality, whether a special offer is available, whether the a ticket for the seat is held by a friend of the user, etc.), wherein the user interface will highlight individual seats and/or seating sections that meet the filter criteria. Optionally, the user may select (e.g., by pointing at or clicking on) an individual seat and/or seating section, and the ticket purchaser user interface will access and display additional information regarding the eat (e.g., whether a special password/offer code is required to purchase tickets for the seat, a seat number, a seat row number, a seat section number, face price, ticket related fees, combined face and fee prices, view information, whether alcohol is permitted, whether the seat is in the shade, etc.).

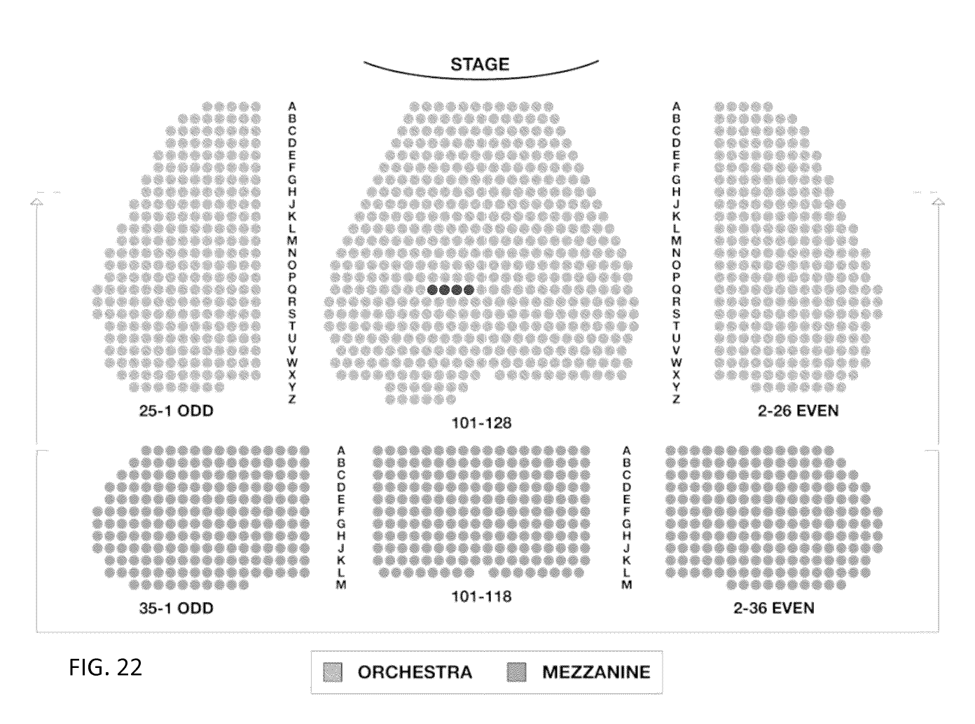

In one implementation, for example, after selecting an event the end-user may be presented with an interactive event venue seat map (see FIG. 22) and an initial listing of all event tickets for sale.

The event listings may include details such as section, row, quantity, and price and may be sorted by the end-user according to such details. The sections of the interactive event venue seat map for which tickets are available may be displayed in color while sections having no available tickets may be displayed in a different color or shade. For example, red, olive, green, blue, teal, orange, etc., each may be used to indicate different functions, prices, status or designations, e.g., sold available, reserved, etc. Optionally, different brightness, shades or tones of the same color can be used to indicate seats chosen by end-user. Optionally, more muted or pastel colors may be used to indicate relatively low grade/inferior seats, and brighter or primary colors may be used to indicate relatively higher grade/superior seats. Other visual indications may be used as well (e.g., different shapes, flashing seat icons may be used to indicate higher grade/superior seats). Those of skill in the art will know other options available to represent the different functions, status and pricing of seats.

By way of further example, with respect to seat colors, dark blue (or other color) may be used to indicate that the seat is available for purchase and matches the user's selected price range and ticket options. Light blue (or other color) may be used to indicate that the seat is available for purchase, but is outside the user's selected price range and/or ticket options. Gray (or other color) may be used to indicate that the seat is not available for purchase. Orange (or other color) may be used to indicate that the cursor is over that seat or the user has already added the seat to the user's selected seats.

In general, the end-user may be provided the same viewing privileges as the user, but without the ability to make changes. Controls are provided via which the end-user can navigate around the map and/or zoom into a certain section of the map. For example, the map is configured to enable an end-user to click on an area of a map and drag the map to change the displayed map area. In certain embodiments, even when an end-user clicks or otherwise selects a particular seating area or section, to thereby expand the view of the selected area, the entire venue is still displayed in an area of the map, with the seat statuses indicated (e.g., via color and/or text). The system may further provide end-user the option to search for different features. For example, if an end-user enters search criteria (e.g., seats having a ticket price between $50-$100), the user interface will highlight (e.g., via color coding or otherwise) the seats and/or sections that match the search criteria. If the end-user then selects a given highlighted section, the end-user interface will zoom in on the selected section, while still displaying an overall view of the venue (which may be reduced in size) in a corner or elsewhere, where the overall view still highlights the seats/sections matching the end-user's search criteria (e.g., seats between $50-$100).

Optionally, if the end-user hovers a pointer (e.g., a cursor) over a certain seat or seating area, or otherwise indicates a seat or seating section (e.g., by clicking on a specific seat or seating area), additional information is provided (e.g., via a pop-up window or overlay) regarding the corresponding seat or seating section. For example, the additional information may include an indication as to whether an offer code is needed, and if so, from which source, the specific seating information (e.g., section, row number, seat number, the ticket price, the type of ticket (e.g., adult-full price, adult-discounted, child, etc.) etc.), an indication as to whether the seating area only has single seats available (and not two or more available adjacent seats). Other information, such as whether the seat is in a covered area or an exposed area, in the shade or in direct sunlight, the distance of the seat to an exit, bathroom, concessions, parking lot, and/or other destination, how far the seat is from an aisle (e.g., expressed as a number of seats and/or in a unit of length, such as feet, meters, or yards), expected temperature at the seat during the event, whether there is waiter service to the seat, and/or other information may be displayed as well.

As illustrated in FIG. 22 the user interface may include a map that graphically (e.g., via a drawing or a photograph) represents a seating chart of the entire venue (optionally with various sections identified graphically, via color coding, and/or via alphanumeric text), and an expanded view of the venue showing individual seats, wherein the user can move a navigation box over the seating chart of the entire venue to select the area that should be shown in the expanded view. Optionally, corresponding colors are used to indicate seat status with respect to availability (e.g., available, sold, on hold, etc.), but not to indicate price, which may be shown textually. Optionally instead, corresponding colors are used to indicate seat ticket price.

In an embodiment of the present invention, the present system enables users to use devices to input images dynamically or on-the-fly. The image that is input into system can be any picture that evolves with the venue, and can be input using any device such as a camera or mobile phone. Generally the photo can be taken from any angle, but preferably from an angle to get a panoramic view of the seats. Alternatively, a view (and captured image) can be taken from the seat. Accordingly, the seating chart may be configured to provide “view from the seat” images (e.g., movies, photographs, graphic renderings, etc.). For example, a user may select/click-on a seat/section and/or an associated icon (e.g., a camera symbol), and the view from the seat or section may be displayed. The image(s) may include one or more static images, a view from the seat, a view to the seat from the performance area, and/or an immersive virtual reality 360 degree or full sphere view. Each icon can be located in the property overview image at the representative location where a digital image was collected, and can depict the direction and perspective of the represented digital image. The digital images can be displayed alongside textual information relating to the depicted space, and can further contain links to lists of textual information regarding an entire structure or property.

### III. Computer Embodiment

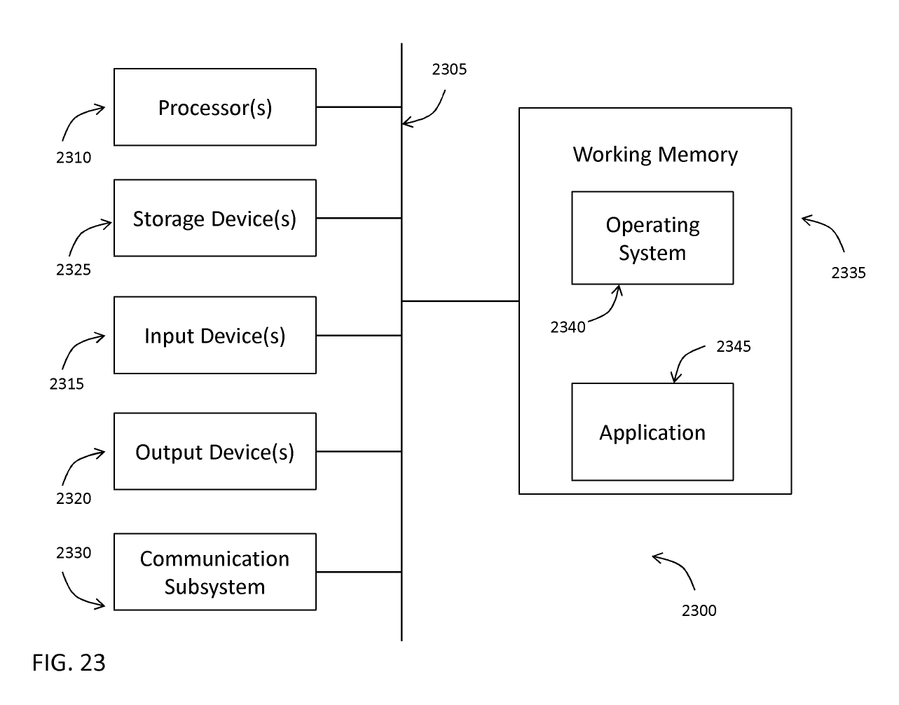

FIG. 23 provides a schematic illustration of one embodiment of a computer system 2300 that can perform the methods of the invention, as described herein. It should be noted that FIG. 23 is meant only to provide a generalized illustration of various components, any or all of which may be utilized as appropriate. FIG. 23, therefore, broadly illustrates how individual system elements may be implemented in a relatively separated or relatively more integrated manner.

The computer system 2300 is shown comprising hardware elements that can be electrically coupled via a bus 2305 (or may otherwise be in communication, as appropriate). The hardware elements can include one or more processors 2310, including without limitation, one or more general purpose processors and/or one or more special purpose processors (such as digital signal processing chips, graphics acceleration chips, and/or the like); one or more input devices 2315, which can include without limitation a mouse, a keyboard and/or the like; and one or more output devices 2320, which can include without limitation a display device, a printer and/or the like.

The computer system 2300 may further include (and/or be in communication with) one or more storage devices 2325, which can comprise, without limitation, local and/or network accessible storage and/or can include, without limitation, a disk drive, a drive array, an optical storage device, a solid state storage device such as a random access memory (“RAM”) and/or a read-only memory (“ROM”), which can be programmable, flash updateable and/or the like. The computer system 2300 might also include a communications subsystem 2330, which can include without limitation a modem, a network card (wireless or wired), an infrared communication device, a wireless communication device and/or chipset (such as a Bluetooth™ device, an 802.11 device, a WiFi device, a WiMax device, cellular communication facilities, etc.), and/or the like. The communications subsystem 2330 may permit data to be exchanged with a network (such as the network described below, to name one example), and/or any other devices described herein. In many embodiments, the computer system 2300 will further comprise a working memory 2335, which can include a RAM or ROM device, as described above.

The computer system 2300 also can comprise software elements, shown as being currently located within the working memory 2335, including an operating system 2340 and/or other code, such as one or more application programs 2345, which may comprise computer programs of the invention, and/or may be designed to implement methods of the invention and/or configure systems of the invention, as described herein. Merely by way of example, one or more procedures described with respect to the method(s) discussed above might be implemented as code and/or instructions executable by a computer (and/or a processor within a computer). A set of these instructions and/or codes might be stored on a computer-readable storage medium, such as the storage device(s) 2325 described above. In some cases, the storage medium might be incorporated within a computer system, such as the system 2300. In other embodiments, the storage medium might be separate from a computer system (i.e., a removable medium, such as a compact disc, etc.), and is provided in an installation package, such that the storage medium can be used to program a general-purpose computer with the instructions/code stored thereon. These instructions might take the form of executable code, which is executable by the computer system 2300 and/or might take the form of source and/or installable code, which, upon compilation and/or installation on the computer system 2300 (e.g., using any of a variety of generally available compilers, installation programs, compression/decompression utilities, etc.), then takes the form of executable code.

It will be apparent to those skilled in the art that substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

In one aspect, the invention employs a computer system (such as the computer system 2300) to perform methods of the invention. According to a set of embodiments, some or all of the procedures of such methods are performed by the computer system 2300 in response to processor 2310 executing one or more sequences of one or more instructions (which might be incorporated into the operating system 2340 and/or other code, such as an application program 2345) contained in the working memory 2335. Such instructions may be read into the working memory 2335 from another machine-readable medium, such as one or more of the storage device(s) 2325. Merely by way of example, execution of the sequences of instructions contained in the working memory 2335 might cause the processor(s) 2310 to perform one or more procedures of the methods described herein.

The terms “machine-readable medium” and “computer readable medium,” as used herein, refer to any medium that participates in providing data that causes a machine to operate in a specific fashion. In an embodiment implemented using the computer system 2300, various machine-readable media might be involved in providing instructions/code to processor(s) 2310 for execution and/or might be used to store and/or carry such instructions/code (e.g., as signals). In many implementations, a computer-readable medium is a physical and/or tangible storage medium. Such a medium may take many forms, including but not limited to, non-volatile media, volatile media, and transmission media. Non-volatile media includes, for example, optical or magnetic disks, such as the storage device(s) 2325. Volatile media includes, without limitation, dynamic memory, such as the working memory 2335. Transmission media includes coaxial cables, copper wire and fiber optics, including the wires that comprise the bus 2305, as well as the various components of the communications subsystem 2330 (and/or the media by which the communications subsystem 2330 provides communication with other devices). Hence, transmission media can also take the form of waves (including without limitation radio, acoustic and/or light waves, such as those generated during radio wave and infrared data communications).

Common forms of physical and/or tangible computer-readable media include, for example, a floppy disk, a flexible disk, a hard disk, magnetic tape, or any other magnetic medium, a CD-ROM, any other optical medium, punchcards, papertape, any other physical medium with patterns of holes, a RAM, a PROM, an EPROM, a FLASH-EPROM, any other memory chip or cartridge, a carrier wave as described hereinafter, or any other medium from which a computer can read instructions and/or code.

Various forms of machine-readable media may be involved in carrying one or more sequences of one or more instructions to the processor(s) 2310 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 2300. These signals, which might be in the form of electromagnetic signals, acoustic signals, optical signals and/or the like, are all examples of carrier waves on which instructions can be encoded, in accordance with various embodiments of the invention.

The communications subsystem 2330 (and/or components thereof) generally will receive the signals, and the bus 105 then might carry the signals (and/or the data, instructions, etc., carried by the signals) to the working memory 2335, from which the processor(s) 2310 retrieves and executes the instructions. The instructions received by the working memory 2335 may optionally be stored on a storage device 2325 either before or after execution by the processor(s) 2310.

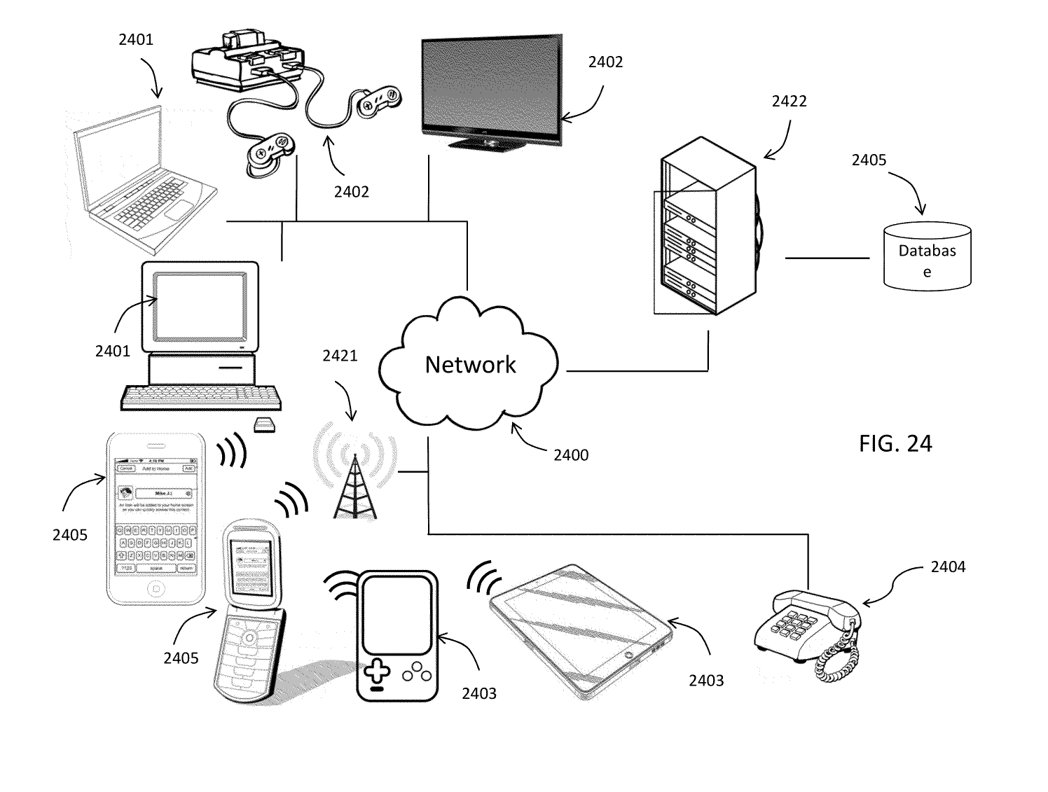

Merely by way of example, FIG. 24 illustrates a schematic diagram of a system 2400 that can be used in accordance with one set of embodiments. The system 2400 can include one or more user computers 205. The user computers 205 can be general purpose personal computers (including, merely by way of example, personal computers and/or laptop computers running any appropriate flavor of Microsoft Corp.'s Windows™ and/or Apple Corp.'s Macintosh™ operating systems) and/or workstation computers running any of a variety of commercially available UNIX™ or UNIX-like operating systems. These user computers 205 can also have any of a variety of applications, including one or more applications configured to perform methods of the invention, as well as one or more office applications, database client and/or server applications, and web browser applications. Alternatively, the user computers 205 can be any other electronic device, such as a thin-client computer, media computing platforms 1202 (e.g., gaming platforms, or cable and satellite set top boxes with navigation and recording capabilities), handheld computing devices (e.g., PDAs, tablets or handheld gaming platforms) 1203, conventional land lines 1204 (wired and wireless), mobile (e.g., cell or smart) phones 205 or tablets, or any other type of portable communication or computing platform (e.g., vehicle navigation systems), capable of communicating via a network (e.g., the network 210 described below) and/or displaying and navigating web pages or other types of electronic documents. Although the exemplary system 200 is shown with three user computers 205, any number of user computers can be supported.

Certain embodiments of the invention operate in a networked environment, which can include a network 210. The network 210 can be any type of network familiar to those skilled in the art that can support data communications using any of a variety of commercially available protocols, including without limitation TCP/IP, SNA, IPX, AppleTalk, and the like. Merely by way of example, the network 210 can be a local area network (“LAN”), including without limitation an Ethernet network, a Token-Ring network and/or the like; a wide-area network (WAN); a virtual network, including without limitation a virtual private network (“VPN”); the Internet; an intranet; an extranet; a public switched telephone network (“PSTN”); an infrared network; a wireless network, including without limitation a network operating under any of the IEEE 802.11 suite of protocols, the Bluetooth™ protocol known in the art, and/or any other wireless protocol; and/or any combination of these and/or other networks.

Embodiments of the invention can include one or more server computers 215. Each of the server computers 215 may be configured with an operating system, including without limitation any of those discussed above, as well as any commercially (or freely) available server operating systems. Each of the servers 215 may also be running one or more applications, which can be configured to provide services to one or more clients 205 and/or other servers 215.

Merely by way of example, one of the servers 215 may be a web server, which can be used, merely by way of example, to process requests for web pages or other electronic documents from user computers 205. The web server can also run a variety of server applications, including HTTP servers, FTP servers, CGI servers, database servers, Java™ servers, and the like. In some embodiments of the invention, the web server may be configured to serve web pages that can be operated within a web browser on one or more of the user computers 205 to perform methods of the invention.

The server computers 215, in some embodiments, might include one or more application servers, which can include one or more applications accessible by a client running on one or more of the client computers 205 and/or other servers 215. Merely by way of example, the server(s) 215 can be one or more general purpose computers capable of executing programs or scripts in response to the user computers 205 and/or other servers 215, including without limitation web applications (which might, in some cases, be configured to perform methods of the invention). Merely by way of example, a web application can be implemented as one or more scripts or programs written in any suitable programming language, such as Java™, C, C#™ or C++, and/or any scripting language, such as Perl, Python, or TCL, as well as combinations of any programming/scripting languages. The application server(s) can also include database servers, including without limitation those commercially available from Oracle™, Microsoft™, Sybase™, IBM™ and the like, which can process requests from clients (including, depending on the configuration, database clients, API clients, web browsers, etc.) running on a user computer 205 and/or another server 215. In some embodiments, an application server can create web pages dynamically for displaying the information in accordance with embodiments of the invention. Data provided by an application server may be formatted as web pages (comprising HTML, Javascript, etc., for example) and/or may be forwarded to a user computer 205 via a web server (as described above, for example). Similarly, a web server might receive web page requests and/or input data from a user computer 205 and/or forward the web page requests and/or input data to an application server. In some cases a web server may be integrated with an application server.

The seating map can be generated and stored in variety of formats including known and proprietary vector graphics formats such as vector graphics formats and raster graphics formats. Vector graphics (also called geometric modeling or object-oriented graphics) utilize geometrical primitives such as points, lines, curves, and polygons to represent images. Examples of vector graphics formats include the Scalable Vector Graphics (SVG) and Vector Markup Language (VML) formats. The SVG format is defined at W3C, Scalable Vector Graphics (SVG), w3.org/Graphics/SVG/. VML is described in Brian Matthews, et al., Vector Markup Language (VML), w3.org/TR/1998/NOTE-VML-19980513. Alternatively, the images can be converted to or maintained in a raster graphics format, which is a representation of images as a collection of pixels. Examples of raster graphics formats include JPEG, TIFF, RAW, PNG, GIF, and BMP. For example, any number of computer programming languages, such as the Java language, JavaScript, Java Applet technology, C, C++, Perl, Pascal, Smalltalk, FORTRAN, assembly language, HTML (i.e., Hypertext Markup Language), DHTML (i.e., Dynamic Hypertext Markup Language), XML (i.e., eXtensible Markup Language), XLS (i.e., eXtensible Style Language), SVG (i.e., Scalable Vector Graphics), VML (i.e., Vector Markup Language), Macromedia's Flash technology, and the like, may be used to implement aspects of the present invention. Further, various programming approaches such as procedural, object-oriented or artificial intelligence techniques may be employed, depending on the requirements of each particular implementation.

In one embodiment, the present invention uses object recognition techniques to capture the outline of the venue, section and/or each individual seat, as well as text recognition techniques to capture identity information, if any, from any scanned or input image. In an image such as a picture, object recognition can be performed by analyzing the image to identify specific objects such as structural landmarks, such as open spaces, stages, fields, walls, columns, doorways, seats, benches, tables, and the like. In schematics, object recognition can be performed on representative shapes of seats and structural landmarks. Preferably, the object recognition engine will look for seats, bench, or chairs, tables or other seating arrangements within the image which can be generally transformed into representative shapes for seating charts. Object recognition software that can be utilized include those that are developed by Google, Toshiba, or ones that utilize vision computing techniques such as machine learning/pattern recognition to identify specific objects in images. Those of skill in the art will be able to identify suitable techniques for identifying particular objects from images and drawings, particularly for the present invention. It should be noted that various object detection processes can be utilized by the present invention. One example of an object detection process is discussed in U.S. patent application entitled “Object Recognition Using HAAR Features and Histograms of Oriented Gradients”, U.S. application Ser. No. 13/085,985. Another example of an object detection process is discussed in the U.S. patent application entitled “Detection of Objects in Digital Images”, U.S. application Ser. No. 13/086,023. A general review of object recognition can be found in Cyganek, B., Object Detection and Recognition in Digital Images: Theory and Practice. (John Wiley & Sons, Ltd, 2013).

In accordance with further embodiments, one or more servers 215 can function as a file server and/or can include one or more of the files (e.g., application code, data files, etc.) necessary to implement methods of the invention incorporated by an application running on a user computer 205 and/or another server 215. Alternatively, as those skilled in the art will appreciate, a file server can include all necessary files, allowing such an application to be invoked remotely by a user computer 205 and/or server 215. It should be noted that the functions described with respect to various servers herein (e.g., application server, database server, web server, file server, etc.) can be performed by a single server and/or a plurality of specialized servers, depending on implementation-specific needs and parameters.

In certain embodiments, the system can include one or more databases. The location of the database(s) is discretionary. Merely by way of example, a database might reside on a storage medium local to (and/or resident in) a server (and/or a user computer). Alternatively, a database can be remote from any or all of the computers, so long as the database can be in communication (e.g., via the network) with one or more of these. In a particular set of embodiments, a database can reside in a storage-area network (“SAN”) familiar to those skilled in the art. (Likewise, any necessary files for performing the functions attributed to the computers can be stored locally on the respective computer and/or remotely, as appropriate.) In one set of embodiments, the database can be a relational database, such as an Oracle™ database, that is adapted to store, update, and retrieve data in response to SQL-formatted commands. The database might be controlled and/or maintained by a database server, as described above, for example.

The embodiments and implementations described above are presented in sufficient detail to enable those skilled in the art to practice the invention, and it is to be understood that other implementations may be utilized and that structural changes and/or substitutions of various elements may be made without departing from the scope and spirit of present invention. The following detailed description is, therefore, not to be construed in a limited sense. Additionally, the various embodiments of the invention as described may be implemented in the form of software running on a general purpose computer, in the form of a specialized hardware, or combination of software and hardware.

We claim:

1. An electronic seating chart generation system in an electronic system for generating a digital interactive seating chart comprising:
a graphic seating map generator that generates a digital seating map from an image of a venue;
a seat database comprising fields for storing locations of seats in the venue;
a seat identity generator associated with the seat database and configured to generate and store seating information, wherein the seating information is associated with the digital seating map and the seat identity generator is configured to generate a dynamic interactive seating chart.

2. The system of claim 1, wherein the digital map is a digital visual representation of the venue, section or individual seats.

3. The system of claim 2, wherein the system is configured to generate the digital representation from a graphical input, a manual input, or an automatic generation process.

4. The system of claim 3, wherein the system is configured to receive a user-input image, and the image is scanned and displayed to the user on a display.

5. The system of claim 4, further comprising an object recognizer module configured to generate a map of the venue and/or seats.

6. The system of claim 5, wherein object recognizer module is programmed to recognize the boundaries of a venue, section and/or individual seats.

7. The system of claim 4, wherein the system comprises a manual input that allows a user to generate a digital map of the venue and/or seats.

8. The system of claim 7, wherein system provides predetermined shapes that can be overlaid onto the venue, section of the venue or one more seats.

9. The system of claim 8, wherein the predetermined shapes displayed to the user are determined through a wizard that dynamically presents templates based on the user's input.

10. The system of claim 7, wherein the system comprises an input for receiving dimensions of the venue or a section of the venue to generate an outline of the venue or section.

11. The system of claim 3, wherein the system further comprises a manual wizard configured to create a digital grid that is translated into a digital seating map.

12. The system of claim 3, wherein the seat identity generator is further configured to designate a specific identifier for each seat in the venue.

13. The system of claim 12, wherein the seat identifier is automatically generated based on the seating map.

14. The system of claim 12, wherein the system allows modifications to the seat identifier by the user.

15. The system of claim 12, wherein the seat identifier is associated with a seat on the seating map.

16. The system of claim 12, wherein the system stores additional information about each seat on the seating map.

17. The system of claim 16, wherein the seat identifier and additional information created from the seat identity generator are linked to additional data stores for providing additional seat information.

18. The system of claim 3, further comprising an electronic ticketing system configured to allow visualization and display seating inventory information.

19. A method in an electronic system for generating a dynamic seating chart for a venue, comprising:
generating a digital seating map;
generating a seating identifier associated with a seating database; and
linking the seating identifier with the digital seating map.

20. The method of claim 19, further comprising providing an electronic ticket to a seat in the venue associated with the seating identifier.
